(19) United States
(12) Patent Application Publication
(10) Pub. No.: US 2010/0274635 A1
(43) Pub. Date: Oct. 28, 2010

(54) Business Lifecycle Management Methods

(75) Inventors: Steven D. Flinn, Houston, TX (US); Naomi Felina Moneypenny, Houston, TX (US)

Correspondence Address: MANYWORLDS, INC., 510 BERING DRIVE, SUITE 470 (IP DEPARTMENT), HOUSTON, TX, 77057, US

(73) Assignee: MANYWORLDS, INC., Houston, TX (US)

(21) Appl. No.: 12/830,340

(22) Filed: Jul. 4, 2010

Related U.S. Application Data
(63) Continuation of application No. 11/154,068, filed on Jun. 15, 2005.
(60) Provisional application No. 60/587,370, filed on Jul. 14, 2004.

(51) Int. Cl. G06Q 10/00

(52) U.S. Cl. 705/10

(57) ABSTRACT

In accordance with the embodiments described herein, methods of applying computer-implemented business lifecycle processes are disclosed, including process lifecycle and solution lifecycle processes. These methods may further apply frameworks and models associated with industry lifecycle, customer lifecycle, product lifecycle, and knowledge lifecycle.

### CROSS-REFERENCE TO RELATED APPLICATIONS

The present application is a continuation of U.S. patent application Ser. No. 11/154,068 which claimed priority under 35 U.S.C. §119(e) to U.S. Provisional Patent Application Ser. No. 60/587,370, entitled “A Method and System for Integrated Business Strategy and Performance,” filed Jul. 14, 2004.

### FIELD OF INVENTION

This invention relates to business strategy and performance improvement methods and systems to support the methods.

### BACKGROUND

The work of Harvard Professor Michael Porter on competitive strategy is commonly seen as the foundation of contemporary business strategy. His book, “Competitive Strategy”, published in 1980, essentially defined the field. Porter developed a framework for business value creation within the dynamics of an overall industry.

Since that defining era of modern business strategy, there have been many variations on Professor Porter's themes. These variations have tended to have a business “positioning” flavor, and they tend to have several dimensions that define a space in which to position—some examples of dimensions include operational efficiency, customer relationships, product-driven innovation. The emphasis of this “positioning” school of strategy is the concept that a business must choose to focus on one of these dimensions. The idea is that a business cannot be generally exceptional versus competition on more than one dimension.

More recently, driven by the explosion of the Internet and related economic drivers associated with the “new economy”, business strategy tended to take on a more technologically-driven flavor. The economics and behaviors of networks became more prominent elements of strategy as the Internet phenomenon expanded. A key concept was positive returns based on network effects. This meant that in these “new economy” strategy paradigms, first mover advantage was often viewed as paramount, due to the assumed winner-take-all economic environment in which a business operated.

In the early 1990's, a business process emphasis developed to improve business performance. For a while, the new business process paradigm seemed poised to dominate business strategy thinking. For both the classic and new economy strategy schools, the emphasis was on choosing an optimal strategic position, but neither school provided much in the way of tangible guidance to businesses on how to migrate to the preferred strategic position, and survive and thrive while doing so.

Business strategy and business processes therefore remain un-integrated approaches in the prior art. Furthermore, technologically-driven themes and approaches associated with business positioning and industry evolution generally remain isolated from both classic business strategy and business process approaches in the prior art. In addition, capability-based strategies, in particular, those pertaining to intellectual capital management such as knowledge management and managing learning processes and organizations are not well-integrated with strategic and process approaches in the prior art. The result is that businesses that apply one or more of these separate approaches find that the business performance improvements sought either do not materialize at all, or are ephemeral.

Further, there is a lack of a well-defined process and associated supporting systems and tools to enable continuous business performance improvement.

Hence, there is a need for an improved method and system for establishing and sustaining business performance improvement.

### SUMMARY OF INVENTION

In accordance with the embodiments described herein, a system for development and implementation of business and process strategies is disclosed. The present invention represents an integrative approach that includes the integration of business strategy with corresponding value drivers, with business lifecycle methods, including industry lifecycle, customer lifecycle, product lifecycle, solution lifecycle, and process lifecycle methods, as well as knowledge and content lifecycle methods. The present invention may furthermore integrate with the ManyWorlds' Generative Investment™, Adaptive Decision Processes and Adaptive Recombinant Processes methodologies and systems.

### BRIEF DESCRIPTION OF THE DRAWINGS

FIG. 1 is a block diagram of the business lifecycle management process, according to some embodiments;

FIGS. 2A and 2B are block diagrams of two and three dimensional strategic frameworks, according to the prior art;

FIGS. 3A and 3B are diagrams depicting three and four dimensional strategic frameworks translated onto two dimensional polygons, respectively, according to the prior art;

FIG. 4A is a diagram illustrating the business lifecycle strategies and processes procedure of FIG. 1, according to some embodiments;

FIG. 4B is a detailed diagram of the strategic decision framework of FIG. 4A, according to some embodiments;

FIG. 5 is a diagram of a two dimensional strategic model within the competitive dimensions and framework, according to some embodiments;

FIG. 6 is a diagram of competitor directions mapped to the two dimensional strategic model of FIG. 5, according to some embodiments;

FIG. 7 is a diagram of the StrategySpace strategic framework, according to some embodiments;

FIG. 8 is a diagram of value drivers mapped to positions on the StrategySpace strategic framework of FIG. 7, according to some embodiments;

FIG. 9 is a diagram of specific competitive examples applied to the StrategySpace strategic framework of FIG. 7, according to some embodiments;

FIG. 10 is a diagram of specific company examples applied to the StrategySpace strategic framework of FIG. 7, according to some embodiments;

FIG. 11A is a flow diagram of strategic position determination, according to some embodiments;

FIG. 11B is a diagram of strategic position determination integrated with strategic competitive dimensions and framework, according to some embodiments;

FIG. 12A is a diagram illustrating the integration of competitive dimensions and framework positions with the strategic decision framework, according to some embodiments;

FIG. 12B is a flow chart of strategic position-driven decisions, according to some embodiments;

FIG. 12C is a diagram of strategic positions integrated with value driver to process mappings, according to some embodiments;

FIG. 12D is a flow chart of value driver to process mappings, according to some embodiments;

FIG. 13 is a diagram of competitive dimensions and framework integrating with profit models, according to some embodiments;

FIG. 14 is a diagram of another example of competitive dimensions and framework integrating with profit models, according to some embodiments;

FIG. 15 is a diagram of competitive dimensions and framework integrating with a game theoretic model, according to some embodiments;

FIG. 16 is a diagram of industry lifecycle and scenarios and a three stage industry lifecycle model, according to some embodiments;

FIG. 17 is a diagram of strategic framework positions integrating with the three stage industry lifecycle model of FIG. 16, according to some embodiments;

FIGS. 18A and 18B depict specific industry examples mapped to the three stage industry lifecycle model of FIG. 16, according to some embodiments;

FIG. 19 is a diagram of an industry lifecycle model integrating with a scenario modeling procedure, according to some embodiments;

FIG. 20A is a diagram of business lifecycle mega-processes, according to some embodiments;

FIG. 20B is a diagram of strategic framework positions integrating with business lifecycle mega-processes, according to some embodiments;

FIG. 21A is a diagram of business renewal strategies and processes including a product lifecycle strategy model, according to some embodiments;

FIG. 21B is a diagram of business renewal strategies and processes including a customer lifecycle strategy model, according to some embodiments;

FIGS. 22A and 22B are block diagrams of process and organization topologies, according to the prior art;

FIGS. 23A and 23B are block diagrams of sub-processes and activities, according to the prior art;

FIG. 24 is a diagram of process lifecycle strategies including a process lifecycle framework, according to some embodiments;

FIG. 25 is a diagram of process functionality layers, according to some embodiments;

FIG. 26 is a diagram of a process lifecycle management framework, according to some embodiments;

FIG. 27 is a diagram of examples of process migration paths mapped to a process lifecycle management framework, according to some embodiments;

FIG. 28 is a diagram of business renewal strategies and processes including a solution lifecycle process, according to some embodiments;

FIG. 29 is a diagram of the derivation of market or customer value drivers and unfulfilled needs by the solution lifecycle process of FIG. 28, according to some embodiments;

FIG. 30 is a diagram of the mapping of unfulfilled needs to opportunities by the business lifecycle management process of FIG. 1, according to some embodiments;

FIG. 31 is a diagram of knowledge and content lifecycle strategy including a knowledge and content lifecycle model according to some embodiments;

FIG. 32 is a diagram of additional details of the knowledge and content lifecycle model of FIG. 31, according to some embodiments;

FIG. 33 is a diagram of additional details of the knowledge and content lifecycle model of FIG. 31, according to some embodiments;

FIG. 34 is a diagram of mapping information consumer segments to the content lifecycle model of FIG. 31, according to some embodiments;

FIG. 35 is a block diagram describing a business lifecycle management process and associated supporting content and computer applications, according to some embodiments;

FIG. 36 is a block diagram describing an adaptive business lifecycle management process and associated supporting content and computer applications, according to some embodiments; and

FIG. 37 is a diagram of alternative computing topologies of adaptive recombinant processes, according to some embodiments.

### DETAILED DESCRIPTION

In the following description, numerous details are set forth to provide an understanding of the present invention, business lifecycle management. However, it will be understood by those skilled in the art that the present invention may be practiced without these details and that numerous variations or modifications from the described embodiments may be possible.

In accordance with the embodiments described herein, a method and a system for integrated business and process strategy development and application, and business performance improvement, is disclosed.

### Integrated Business Lifecycle Management

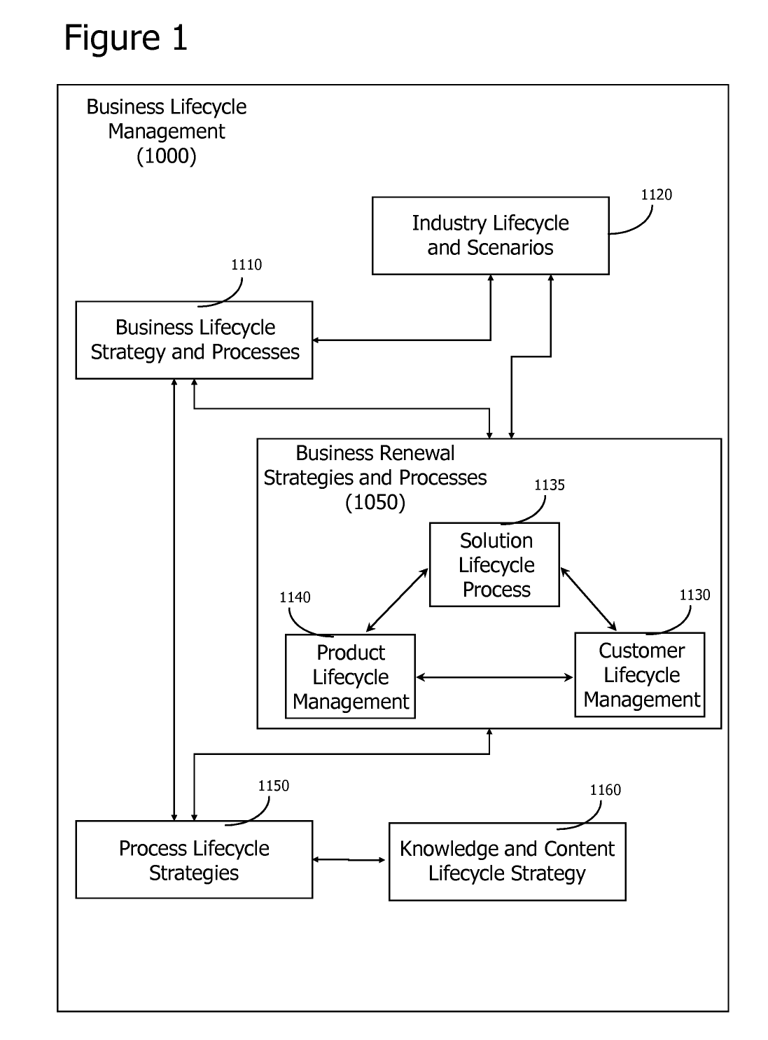

In accordance with some embodiments of business lifecycle management, FIG. 1 depicts an overall integrated business strategy and performance improvement model and process 1000, with an emphasis on a business lifecycle management approach.

Integrated business lifecycle management model 1000 represents a method and system for enabling the development and maintenance of an advantageous strategic positioning of a business, as well as advantageously supporting functional level strategies, and enterprise and functional level processes and infrastructure.

The integrated business lifecycle model 1000 includes business lifecycle strategy and processes 1110, which may be informed by, and/or inform, or integrate with, an industry lifecycle and scenarios model 1120.

The business lifecycle strategy and processes 1110 may guide, and/or be guided by, business renewal strategies and processes 1050 and process lifecycle strategies 1150. The term “business renewal” as used herein refers to those aspects of a business that are associated with new business or growth, as opposed to just maintaining existing business. Business renewal strategies and processes 1050 is comprised of customer lifecycle strategies 1130, product lifecycle strategies 1140, and solution lifecycle processes 1135. Customer lifecycle strategies 1130, product lifecycle strategies 1140, and solution lifecycle processes 1135 mutually inform or interact with each other, as shown in FIG. 1.

Process lifecycle strategies may guide, and/or be guided by, knowledge and content lifecycle strategies 1160.

The integrated business lifecycle model 1000 extends beyond the prior art by explicitly integrating competitive industry positioning, with customer, product, solution and process lifecyle strategies, and with knowledge and content lifecycle strategies. Furthermore, industry, process, solution, knowledge and learning, and content lifecycle approaches are novel and not known in prior art. Customer and product lifecycle approaches are known in the literature, but business lifecycle management orients customer lifecycle from the perspective of the supplying business, not the customer itself. Likewise, although product lifecycle approaches are known in the literature, the approaches are not integrated with an overall business strategic framework, with a customer lifecyle framework, and a process lifecycle framework.

The integrated business lifecycle model 1000 may be applied to improve business performance in situations in which a business strategy already exists, or in situations in which a business strategy must be developed. In other words, a business strategy need only be established, which may include the identification of an existing business strategy, or the development of new business strategy.

### Strategy Framework Design

Business strategy can be thought of as a set of high level decisions that inform subsequent decisions—in other words, strategy is a set of “meta-decisions”.

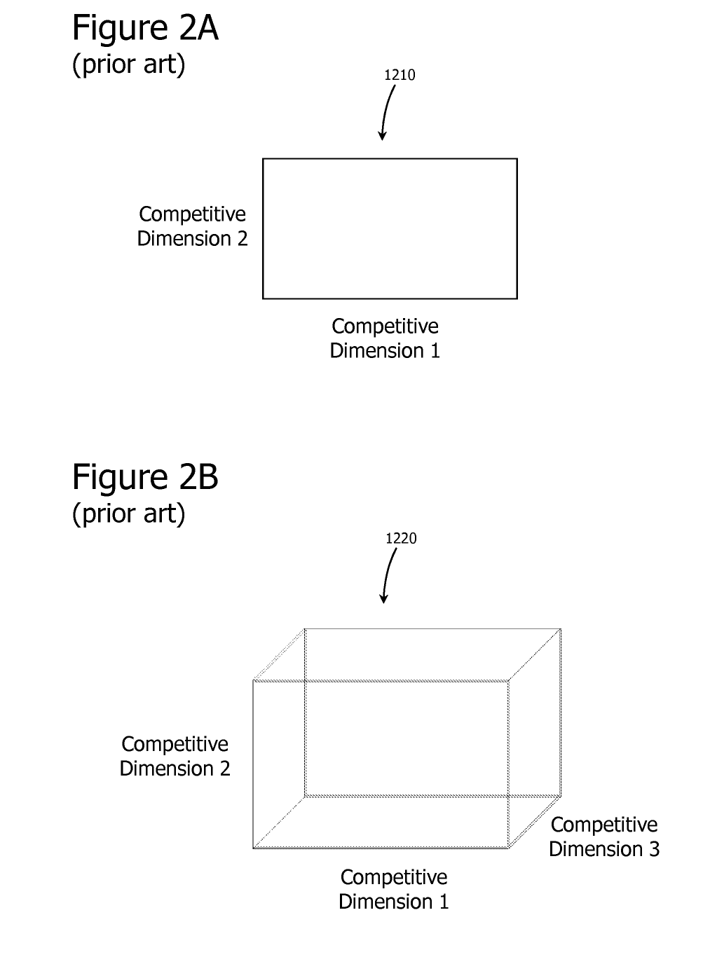

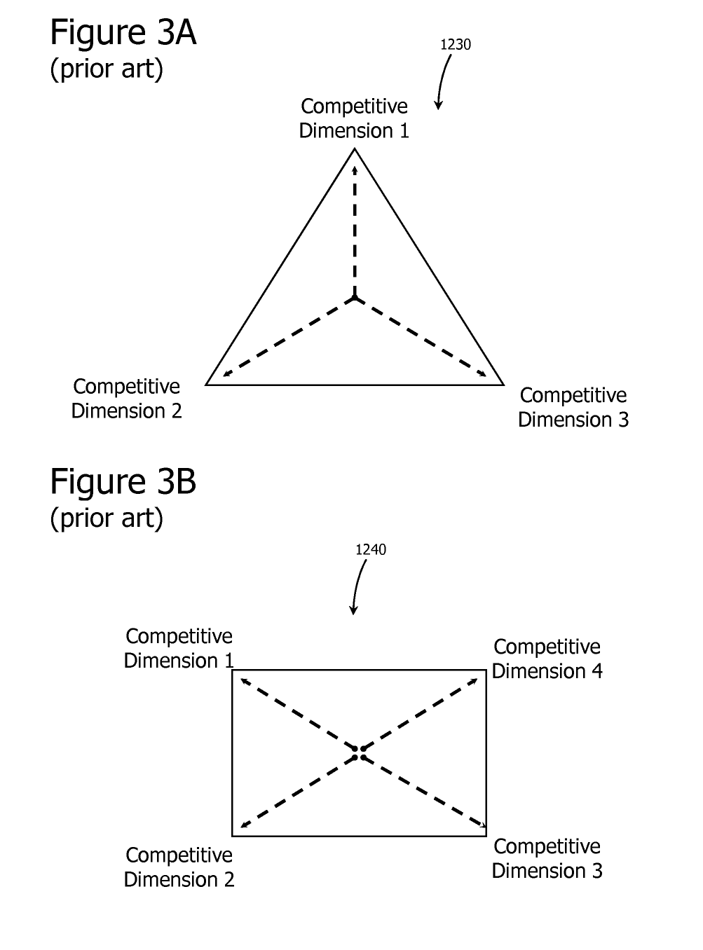

Visual frameworks can provide a convenient structure to capture strategic decisions. The prior art has included visual frameworks that include a plurality of dimensions of strategic choices. These strategic choices are typically dimensions of competitive differentiation. Typical examples of these dimensions include degree of competitive differentiation on cost, degree of customer intimacy and scope of products and services. FIG. 2A depicts a two dimensional strategic visual framework 1210, in a square or rectangular format. FIG. 2B depicts a three dimensional strategic framework 1220, in a cube format. Strategic dimensions may be “flattened” into representations of fewer dimensions through directions from the center of the flattened representation to a vertex. For example, FIG. 3A represents three strategic dimensions in a triangular format 1230, and FIG. 3B represents four strategic dimensions flattened onto a square or rectangle 1240. In general, polygons may be used to depict a number of strategic dimensions, corresponding to the number of vertices of the polygon. Such representations are sometimes referred to as “radar” or “spider” charts.

The integrated business lifecycle model 1000 applies strategy framework design principles that extend beyond those applied by the prior art, yielding a more robust and effective strategy framework. Following are the specific design principles applied by business lifecycle management in some embodiments:
1. The framework should explicitly recognize the business world is adaptive, and therefore no specific business strategy can be expected to be effective for an indefinite period of time.
2. The framework should accommodate the reality that businesses must sometimes migrate from one strategic position to another, and while doing so survive and thrive. A problem with the prior art classic and new economy strategic frameworks is that they typically assumed any position other than an extreme was bad (“stuck in the middle”, for example). So in these frameworks, moving to an extreme was required, but the migration path to the prescribed strategic end state was not explicitly addressed.
3. The framework should be widely applicable—that is, relevant to all industries and businesses.
4. The framework should be extensible it must be applicable to not only a given business, but also enable the analysis of the dynamics of an entire industry
5. The framework should enable a seamless extension from the level of overall strategic positioning to corresponding business value drivers, and business process and organizational designs. In other words, it must serve as a blueprint for actual implementation.
6. The framework should be simple to use, yet powerful enough to generate deep and continuous insights.

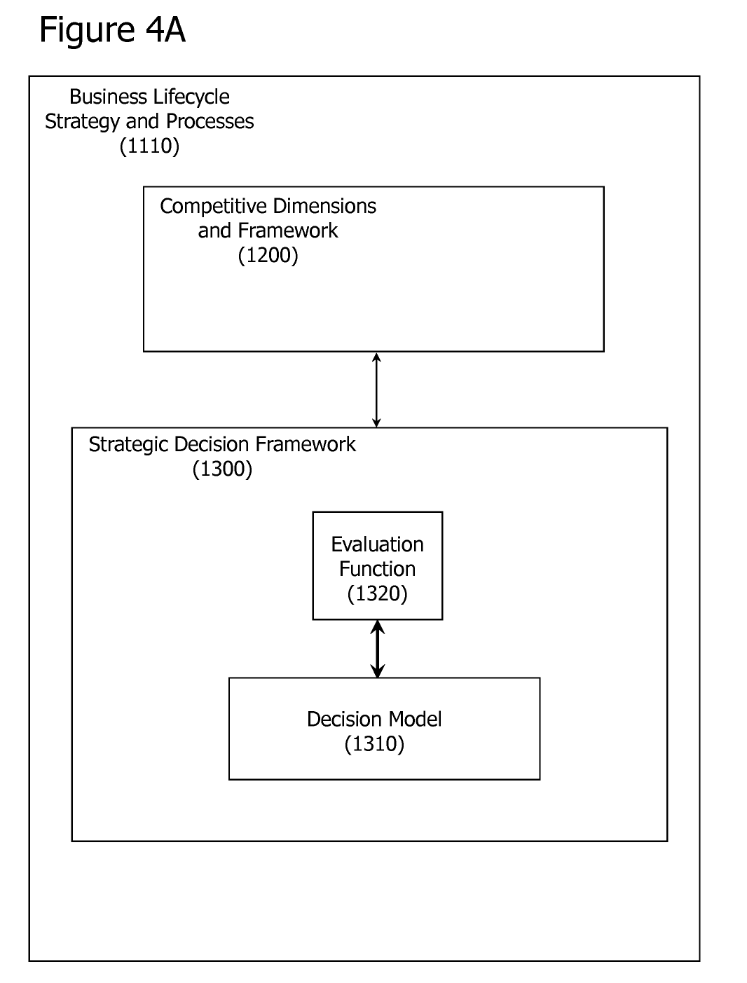

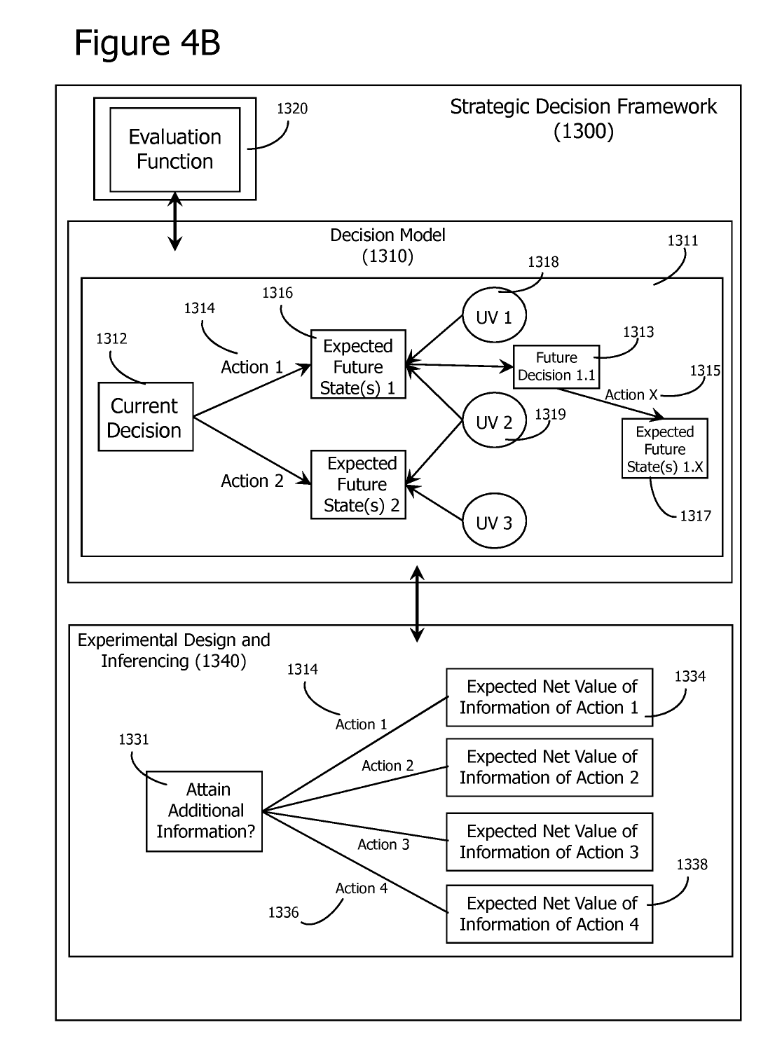

In accordance with the paradigm of strategy serving as “meta-decisions”, FIG. 4A depicts that business lifecycle strategy and processes 1110 may include a competitive dimensions and framework 1200 that may be interactively applied to a strategic decision framework 1300. The competitive dimensions and framework 1200 may include a multi-dimensional strategic framework guided by the strategic framework design principles listed herein, and specific examples of such frameworks are described in a following section of the detailed description.

Strategic decision framework 1300 may include a decision model 1310 and a decision evaluation function 1320 as depicted in FIG. 4A.

The general approach of the decision analysis framework 1300 is to look or forecast ahead, and then work backwards. This approach can guide the development of business strategy, and subsequently, business strategy can serve to guide decision analysis associated with subordinate-level decisions, including decision related to specific business processes. This approach can also enable effective information gathering associated with strategic decisions. In some embodiments, business lifecycle strategy and processes 1110 may apply methods and systems disclosed in U.S. Provisional Patent Application Ser. No. 60/652,578, entitled “Adaptive Decision Process,” filed Feb. 14, 2005, which is incorporated by reference herein, as if set forth in its entirety.

FIG. 4B describes additional details of the decision process 1310. The associated decision may be represented in a decision tree model form 1311, although other models for representing the decision may be applied. The decision tree model 1311 may be derived from other decision modeling techniques, such as influence and relevance models or diagrams. The decision model 1311 is comprised of a current decision 1312, one or more potential actions 1314 that must be decided, and one or more expected future states 1316 that are the expected consequences of the execution of the one or more actions. The future states are influenced by one or more uncertain variables (designated “UV”) 1318. The uncertain variables may be modeled mathematically as discrete or continuous probability functions, and the associated future states may be discrete, or they may be represented mathematically as a continuous function. Continuous functions may be discretized as required to make the decision model 1311 more manageable. Note that an uncertain variable 1319 may influence more than one expected future states.

Second order future decisions 1313 may be identified, conditional on the first order future states 1316, and these second order future decisions 1313 are associated with second order future actions 1315 that lead to a next order or level of future states 1317. Additional levels of decisions, associated actions, future states, and associated uncertain variables may be “chained together” without limit.

An evaluation function 1320 is applied to support the determination of the value of conducting an action 1314. The evaluations of actions 1314 that comprise a current decision 1312 by the evaluation function 1320 may be based on decision criteria that include expected financial benefits, net of expected costs. These financial metrics may include discounted cash flows, yielding a net present value. Alternatively, option-based valuations may be used. Other traditional financial metrics such as internal rate of return or payback time may be used, although these metrics may require additional adjustments to achieve proper results. The net benefits may be adjusted by expectations or probabilities of success, to yield an expected net benefit for an opportunity. (The book, “Investment Science,” Luenberger, 1998, provides a survey of the prior art with regard to investment modeling.)

The evaluation function 1320 may apply adjustments to the calculated value of an action based on factors such as risk (i.e., variance in expected outcomes), including application of utility functions that incorporate risk. In some embodiments, the evaluation function applies a metric to each “leaf” node of the decision tree framework 1311, and then calculates backward to the current decision 1312 to determine the expected values of each possible action path within the decision tree model 1311. The action 1314 with the largest expected value is chosen to be executed. The examples of financial and non-financial criteria applied by the evaluation function 1310 described herein are merely illustrative and not exhaustive. The decision criteria may apply one or more of the financial and non-financial criteria.

The decision 1312 modeled in decision tree model 1311 can be considered the “primary” decision. However, there also exists a meta-decision: the decision as to whether to attain additional information that would be expected to resolve to at least some degree uncertainties corresponding to uncertain variables 1318 that are associated with the primary decision, before making the primary decision 1312. The experimental design and inferencing function 1340 includes this meta-decision 1331, and the associated one or more information gathering actions 1336 expected to result in attainment of additional information that reduce uncertainties associated with the one or more uncertain variables 1318. The expected net value 1338 of each action 1336 is determined by the experimental design and inferencing function 1340. For actions that are independent, the action 1336 with the highest positive expected net value is selected for execution. Depending on timing factors and correlations among actions 1336, more than one action may be selected for execution. If none of the actions 1336, individually or collectively, has an expected net value greater than zero, then no explicit actions regarding attainment of additional information should be conducted.

The expected net value of an action 1336 may include the expected value of the information that will result from action 1336 based on the expected degree of resolution of uncertainty associated with the one or more uncertain variables 1318, as well as the cost of conducting the action 1336. In some embodiments, an adjustment associated with the amount of time to attainment of the information resulting from the action 1336 may be applied.

In some embodiments, the actions associated with attaining additional information may include actions 1314 associated with the primary decision. The expected net value of information 1334 associated with these actions may thus be calculated directly within the experimental design and inferencing function 1340. In other embodiments, this value is determined directly by the evaluation function 1320 as it is applied to the decision model 1310.

Strategic positions defined within multiple competitive dimensions within competitive dimensions and framework 1200 may drive the current decision 1312 of decision models 1310, as well as influence the information gathering decision 1331. Further, the results of actions 1314, 1336 that deliver additional information may influence the strategic positioning within competitive dimensions and framework 1200.

### Strategic Dimensions

In accordance with some embodiments, strategic dimensions may include dimensions of strategic competitive differentiation. The dimensions associated with a strategic framework may include two or more of the following:
1. degree of business focus on product innovation
2. method of development and delivery of products and services,
3. degree of competitive differentiation of product and services
4. degree of business focus on customer relationships
5. type of relationships with customers
6. degree of business focus on supply chain
7. positioning within a value chain or value network
8. degree of streamlining of the value chain or value network
9. cost structure of the value chain
10. degree of complexity of the value chain or value network
11. orientation of the value chain or value network
12. degree of competitive differentiation through business processes

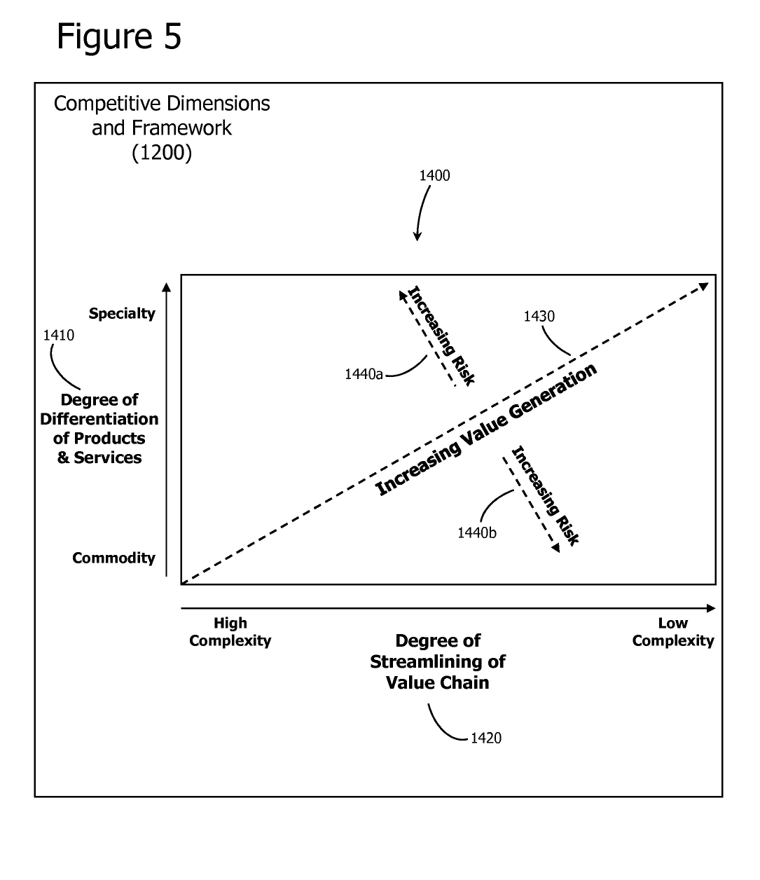

In accordance with some embodiments, a two dimensional strategic framework 1400 applying two of the above dimensions is shown in FIG. 5. The dimensions selected in FIG. 5 are 1) the ability to differentiate products, services, and/or relationships that the customer values and is willing to pay for 1410, and 2) the ability to streamline and reduce costs associated with the development and delivery of products and services across the value chain 1420.

These two dimensions ordinarily compete with one another. It is typically difficult for any business to have highly differentiated products, and at the same time a less complex, low cost value chain. However, exceptional competitive value can be generated by finding approaches to improvement in both dimensions 1430.

Extremes in either of the competitive directions can potentially deliver high levels of value. However, the extremes are more vulnerable to being less applicable to a broader range of business and industry scenarios. These positions, as directionally indicated by indicia 1440a and 1440b, can therefore be considered riskier. In addition to scenario risks, potential overlap of strategic positioning and directions with competitors introduces another layer of risks that must be considered as strategic alternatives are established.

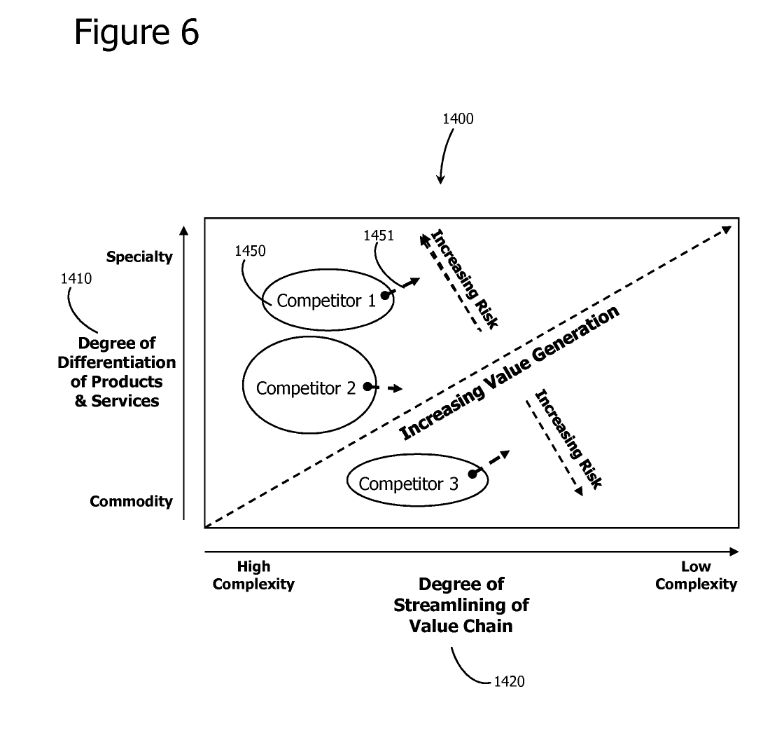

FIG. 6 depicts how competitors may be mapped to the strategic framework in accordance with some embodiments. The current position 1450 may be depicted, along with expected future directions 1451. Size of icons or symbols associated with each competitor may be scaled by financial metrics, such as revenues, profitability, etc.

### StrategySpace Framework

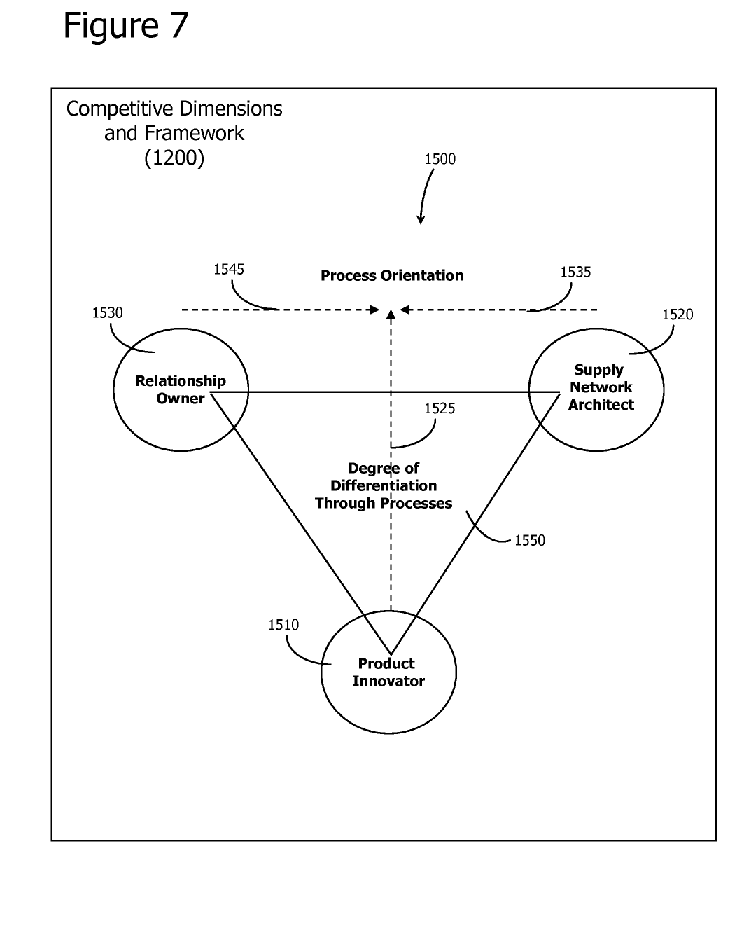

In accordance with some embodiments, FIG. 7 depicts a specific type of strategic framework, the ManyWorlds StrategySpace™ strategic framework 1500, which may be applied within the business lifecycle strategy method 1110 of the integrated business lifecycle management model 1000. The StrategySpace framework 1500 can provide guidance on business direction, and can deliver insights into how business strategies are likely to evolve in the face of upcoming infrastructure and business ecosystems changes.

In accordance with the strategy framework design principles outlined herein, StrategySpace is simple, yet powerfully descriptive—it posits three fundamental or iconic business strategy positions, driven by two process-related dimensions, and a “strategy space” 1550 defined by the three business strategy extremes and the process-related dimensions.

The first position is called “Product Innovator” 1510. Product Innovators represent businesses whose primary focus is on their products and services (it should be understood that the term “product” is meant to include services when used hereinafter). This business strategy's fundamental competitive differentiation is based on the attributes of its products themselves—it lives or dies on this basis. To the extent that processes are important to this business strategy, they are primarily focused on product development-related processes.

The organizational structures of product innovators reflect the relative lack of reliance on large-scale processes—these businesses are almost always organized around product lines. This often implies some level of inefficiency in various functional areas such as finance, HR, manufacturing, etc., because these functions may have considerable duplication across the product lines. This inefficiency is tolerated, however, because being as good as possible in product-related areas brings advantages that overwhelm the inefficiencies.

Almost all businesses start as product innovators 1510—the entrepreneur that initiates the business typically has a better product idea than what is currently available in the marketplace. Therefore the Product Innovator 1510 space can be labeled as the position of “creative destruction”—it is the initial attack on the marketplace incumbents.

Many businesses never leave this product innovator position 1510. But for others, whether by necessity or design, they must begin to rely on points of differentiation versus their competitors on the basis of factors other than the product itself. In general, we can describe these non-product factors as process-related factors. So the degree to which processes in general serve to differentiate marketplace performance versus competitors, is a key dimension 1525 of the StrategySpace model.

As process focus becomes increasingly important, a business also needs to choose the orientation of its process approach. It can choose to focus on building processes and value chains toward customers 1535, or it can choose to start with the customer, and build processes and demand chains back from the customer 1545.

The ultimate conclusion of the first approach can be termed “Supply Network Architect” 1520. These are businesses that are able to design and manage processes that extend across not only their own enterprise, but also across an overall business network. The most successful of these businesses are able to position themselves within their overall business network in a way that maximizes value capture from the network as a whole.

These businesses seek to be in a position in which they uniquely fill a valuable area of the network, and work to ensure that all other areas of the network are filled with intensely competitive complementors. In other words, “one of me, and many of them” is the position these companies strive to achieve and to maintain. Therefore, the Value Network Architect position 1520 can also be termed the “dominate the ecosystem” position.

The ultimate conclusion of the second process orientation approach, the working backwards from the customer orientation 1545, is “Relationship Owner” 1530. These businesses succeed or fail based on the ability to establish a relationship with customers which is more powerful than that of any competitor. Implicit in this business strategy position is the assumption that owning the customer relationship is the most important portion of the strategic real estate. Again, in this position 1530, the key to value capture is “one of me and many of them”. The ideal situation is to have exclusive access to the customer, while suppliers of the Relationship Owner 1530 are numerous and in intense competition, thereby reducing their ability to capture value from the demand chain.

### Core Value Drivers

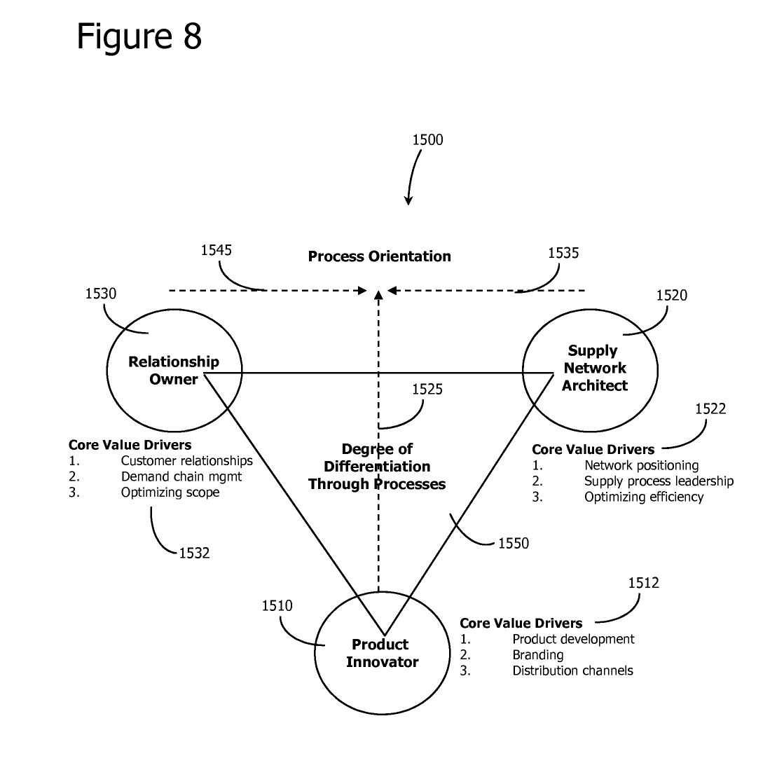

According to some embodiments, as shown in FIG. 8, the three fundamental business strategy positions have very different core value drivers. The term value driver is used herein to denote the aspects or activities of a business that are the most important “levers” of differentiated value creation versus competitors. Value drivers may map directly to financial statements of a business; in particular, the profit and loss (P&L) statement. For example, one value driver may be associated with the revenue line of the P&L, while another value driver may be associated with costs of goods sold.

The Product Innovator position 1510 has as its three core value drivers 1512: 1) product development, 2) branding, and 3), distribution channels. First among equals is the product development value driver—this strategic position can only deliver value if the product or service itself is superior. Branding is extraordinarily important to the Product Innovator, as it represents the “information bundle” that is created in the mind of the customer that embodies the business' product superiority. And access to strong distribution channels is also crucial, as the Product Innovator requires an effective way to deliver its product to its customers, since it is not the customer relationship or distribution channel owner.

The Supply Network Architect 1520 has as its three core value drivers 1522: 1) network positioning, 2) process leadership, and 3) optimizing efficiency. Network positioning is the most critical element of value creation and capture—being in the right place in the network versus in the wrong place in the network can be worth literally orders of magnitudes of value. The value generated by Microsoft software versus Gateway computers, for example, in the personal computer value network illustrates this point. And these businesses do not leave their positioning to happenstance; they are continuously adjusting their position, and when possible, the position of others in the ecosystem, to their advantage.

These businesses also need to demonstrate leadership or best practices in at least a few process areas. The key is to be focused on leadership in the process areas that create the greatest value. For example, Cisco has had sustained process advantages in marketing and acquisitions that has driven superior performance versus its competition.

And a general focus on optimizing for efficiency is critical for this position. Standardization and the application of scale economics are usually highly important for Supply Network Architects 1520. This position often competes with Product Innovators 1510 and Relationship Owners 1530 for customers' business, and neither of these two competing positions is focused on low cost—providing an opportunity for the Supply Network Architect 1520 to win at the cost game.

The Relationship Owner position 1530 has as its three core value drivers 1532: 1) customer relationships, 2) demand chain management, and 3) optimizing scope. Clearly the customer relationship itself is the most important of all—if this relationship is disrupted, the value capture potential of this position is seriously degraded. IBM, in its heyday of the 1970's, was an example of the master of this position—however, when this position was eroded by the technology disruptions of the 1980's, IBM's value capture declined significantly.

The demand chain management value driver refers to the effective management of the chain of activities that delivers product to the customer. The Relationship Owner 1530 may not actually own any of this chain; in fact, it is generally advisable not to, as these processes require very different competencies than owning customer relationships. Nevertheless, the Relationship Owner 1530 is accountable to the customer for delivery, and therefore must effectively manage the demand chain.

The Relationship Owner position 1530 is driven by the economics of scope (versus the economics of scale for the Supply Network Architect). The business in this position never wants to be out-scoped by a competitor, as it may enable the competitor to establish a broader relationship with the customer. On the other hand, a business can extend scope too far, although this is less likely to be fatal versus having insufficient scope. This dynamic in action is observable in the case of Amazon.com, which seeks to be the retail Relationship Owner. In its quest to be successful in that position, it has broadened scope considerably; perhaps too far in some cases—time will tell if that is the case.

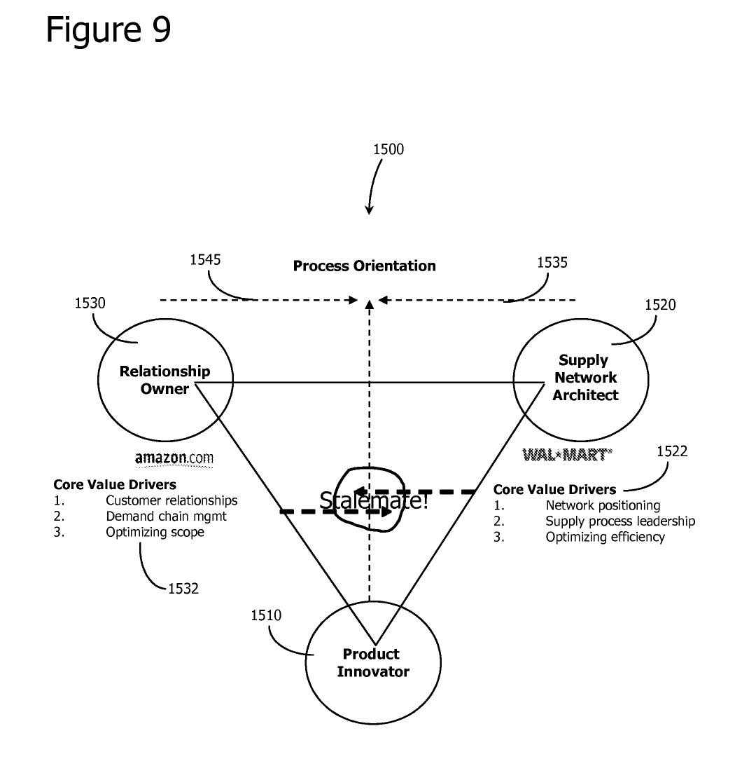

Of course, there is also intense competition among the process-driven business strategies. As depicted in FIG. 9, for example, Wal-Mart with its Supply Network Architect model (at least, originally) and Amazon with its Relationship Owner model, increasingly compete for value. This leads to the conclusion that the first round of this competition has generally led to a stalemate: Amazon has not been entirely successful in assembling a demand chain that is efficient and effective enough, while Wal-Mart initially stumbled somewhat as it has tried to create new relationships with its customers through an Internet-based medium.

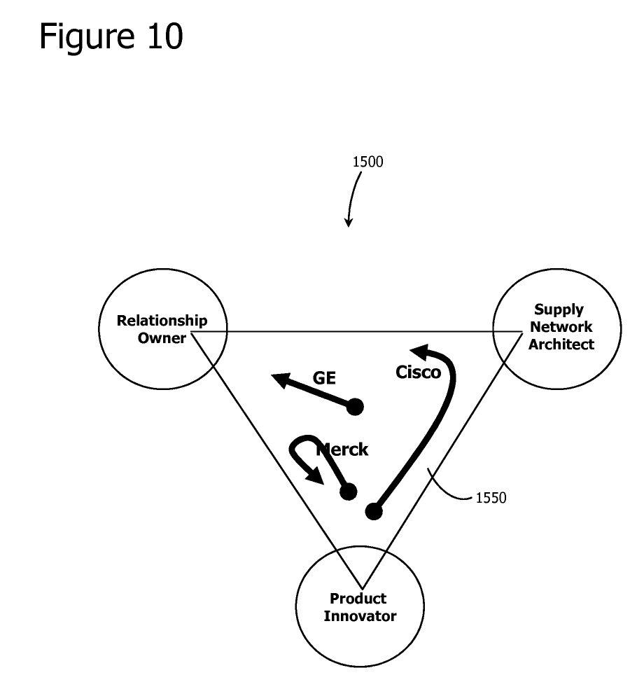

As further examples, FIG. 10 depicts contemporary movements of well known businesses within an embodiment of the StrategySpace framework. The movements of the exemplary businesses and business strategies may be tracked within the “strategy space” 1550 of the StrategySpace framework as shown in FIG. 10.

Cisco is an example of an IT product innovator 1510 that became a technology leader by successfully migrating toward Supply Network Architect position 1520. Cisco made better decisions than their competition on what the key value drivers were for their business (e.g., design, acquisitions) and what were not (e.g., manufacturing). More recently, Cisco has begun to migrate toward solutions concepts.

General Electric (GE) is an example of a collection of a largely undifferentiated set of businesses in the 1980's that Jack Welch turned into a solutions powerhouse, fueled in large degree by the financial solutions “glue” of GE Capital.

Merck is an example of a premier product company that began moving towards a Relationship Owner model 1530 in the face of buyer-side consolidation (health insurance consortia, etc.). When this movement did not yield results, they attempted to migrate back to their original position. Unfortunately, they failed to keep up with their competition in the product development arena and subsequently went into a competitive decline.

### Applying the StrategySpace Model

According to some embodiments, a few key points should be borne in mind when applying the StrategySpace model. First, there is not necessarily one best business strategy position. The value creation capability of any particular position is a function of what is happening in the entire business ecosystem. The business ecosystem learns and adapts accordingly. If a particular business strategy position has produced outstanding performance in the past, there will be a lot of imitators. A crowded position reduces value for all of the players, so what worked before may not work in the future—in fact, generally it is just the opposite.

This implies strategic success often means being a contrarian—again, “one of you, many of them”.

Sometimes the greatest value creation potential lies at the three primary business strategy positions. However, a business cannot just “magically” arrive at these or another position. It needs to migrate to the position from elsewhere—usually from some intermediate position in StrategySpace. It is effectively managing these migrations that often separate the highly successful businesses from all of the others.

In some embodiments, value drivers are derived from the positioning of the business, on an historical, current or future basis, through application of functions or algorithms. In some embodiments, the algorithm applies a function that calibrates the value drivers based on the relative distance of the strategic position from the vertices of the strategic framework that are mapped to specific value drivers. The function may be linear or non-linear. The strategic framework may be StrategySpace 1500 or an alternative strategic framework.

In some embodiments, the visual framework and the algorithm to determine value drivers that correspond to positions are implemented on an interactive computer system.

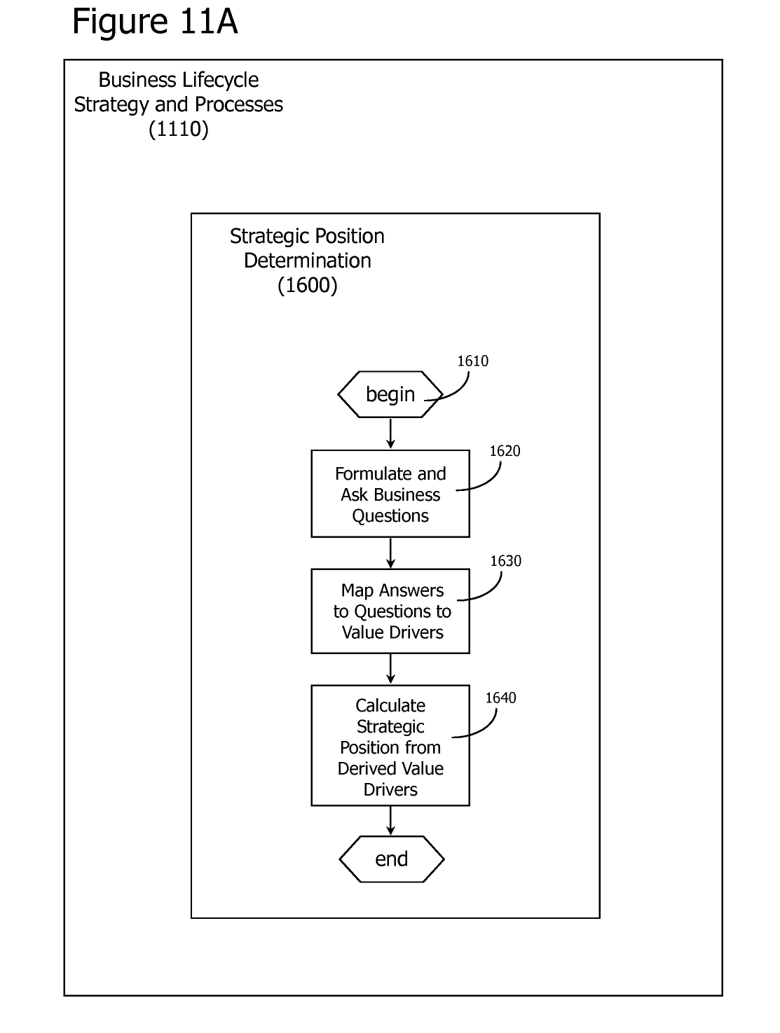

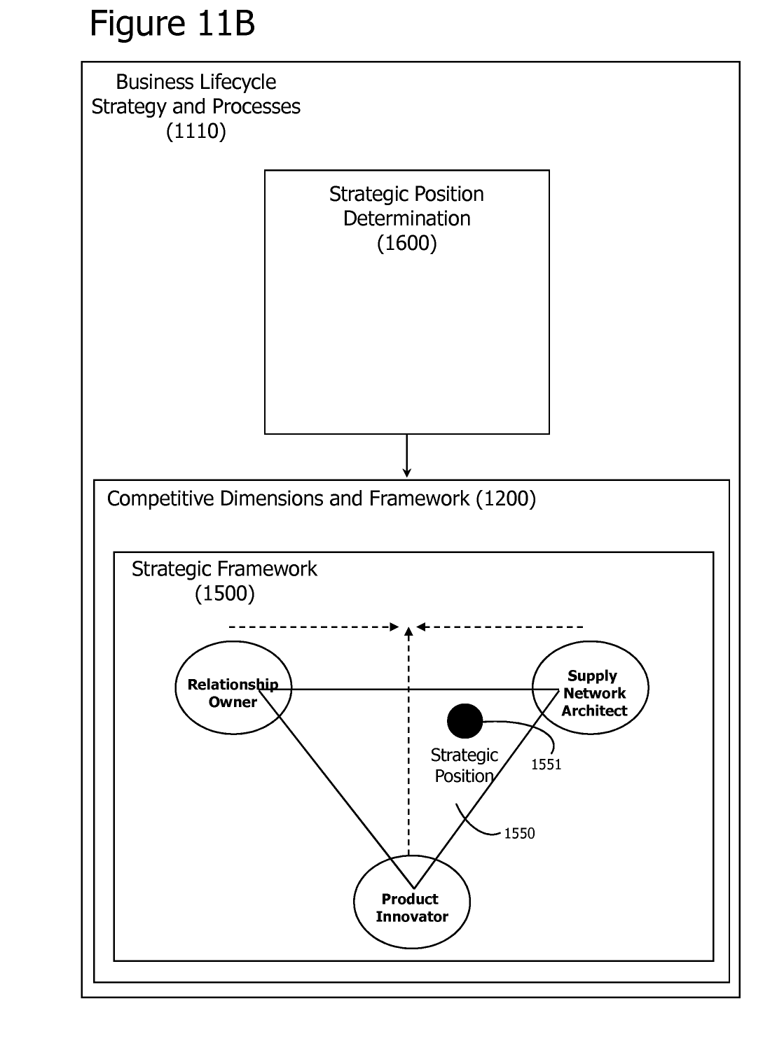

In some embodiments, as depicted in FIG. 11A, the reverse operation may be implemented—that is, a series of questions may be posed, and based on the answers to these questions, the position on the strategic framework may be determined and displayed. The questions asked have correspondences to value drivers that in turn map to positions on the strategic framework. In some embodiments, this approach is implemented on a computer system. The questions may be asked of an individual, or a set of individuals, with an appropriate function applied to yield a position that is collectively determined. In FIG. 11A, an exemplary flow is shown of this method within the strategic position determination process 1600 that is within the business lifecycle strategy and processes function 1110. The procedure begins 1610, and an appropriate business question is formulated and asked of one or more individuals 1620. The answers to the one or more questions posed to one or more individuals are assimilated and mapped to value drivers 1630. This procedure 1630 may include applying appropriate statistical algorithms to the answers. The strategic position or positions are then calculated 1640 from the value driver mappings. The calculated strategic positions may be delivered or displayed to users through a computer-based system and display.

FIG. 11B illustrates the process described in FIG. 11A using the StrategySpace strategic framework 1500. The strategic position or positions that are calculated 1640 from the value driver mappings are then represented in the competitive dimensions and framework 1200, which includes the StrategySpace framework 1500 in this example. Strategic position 1551 calculated 1640 is displayed as shown in FIG. 11B. Although in FIG. 11B, the StrategySpace framework 1500 is used in the example, it should be understood that the integrated business lifecycle model 1110 may apply other types of strategy frameworks.

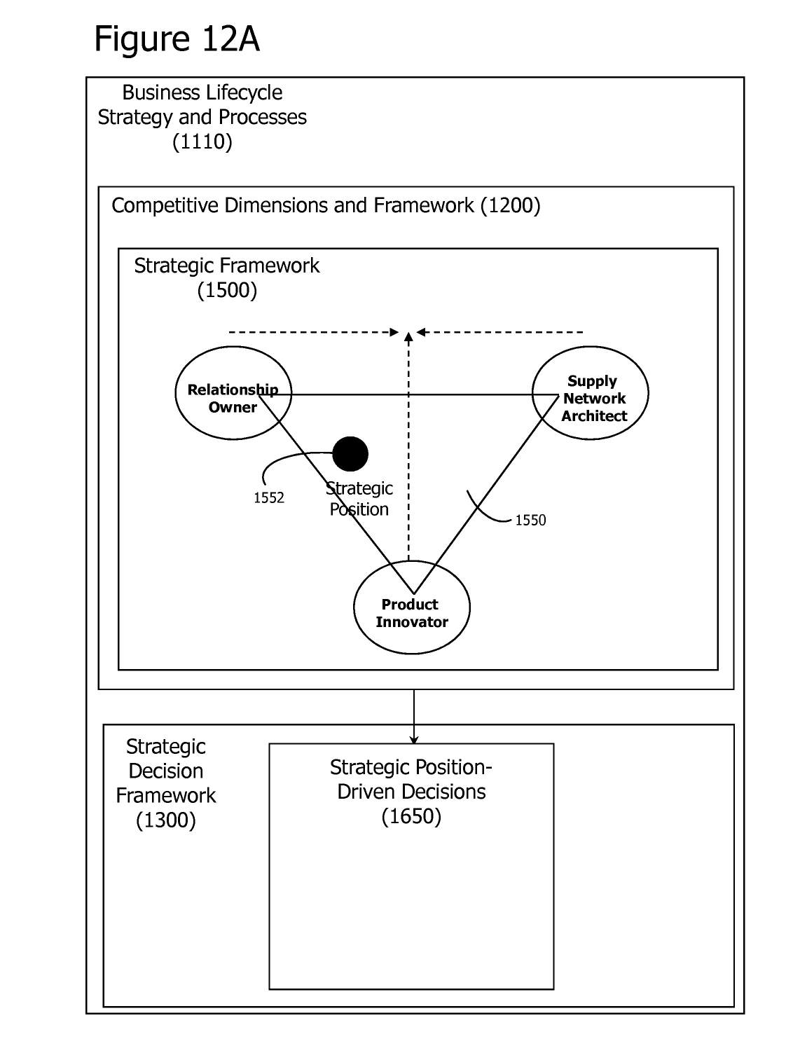

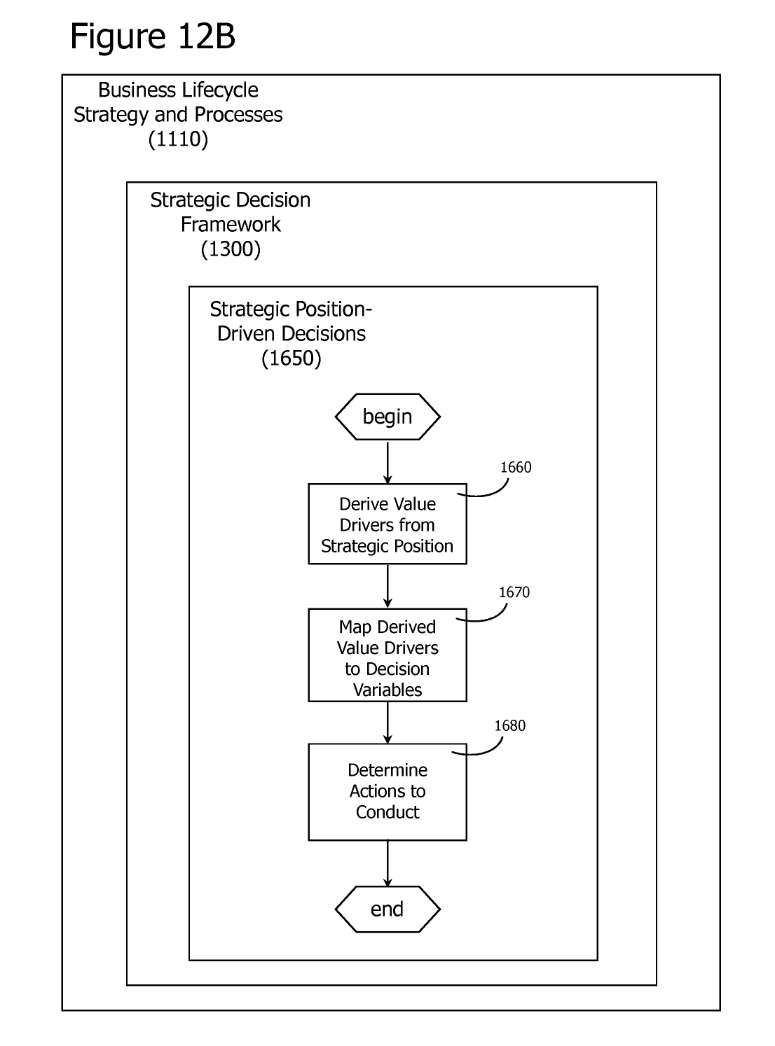

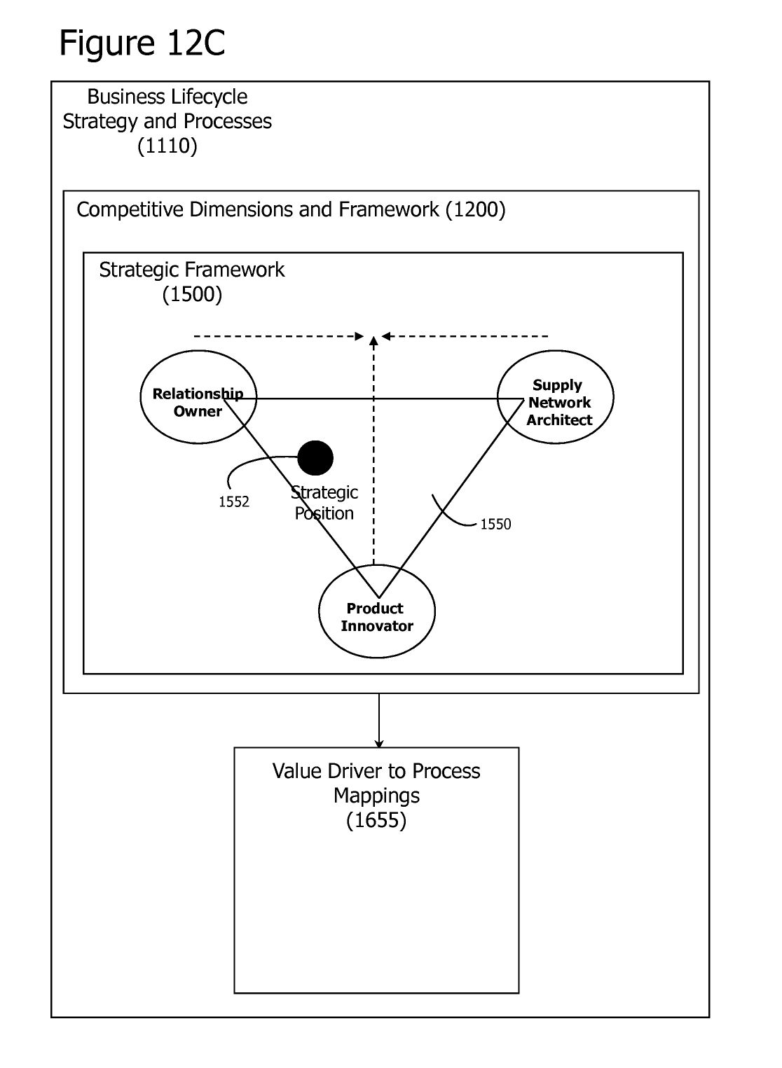

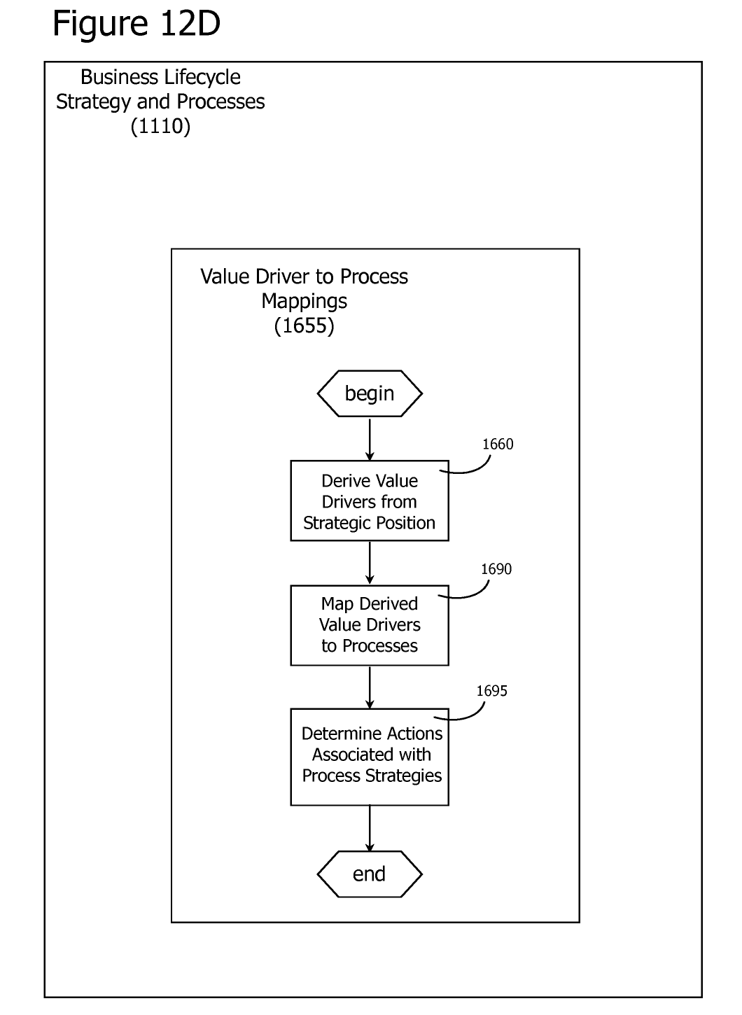

FIG. 12A depicts a position 1552 on a strategic framework 1500 (or any other type of multidimensional strategic framework) driving decisions within strategic decision framework 1300. Strategic decision framework 1300 includes a strategic position driven decisions procedure 1650 in which position 1552 influences the decision model and decisions within strategic decision framework 1300.

FIG. 12B depicts the process flow of strategic position-driven decisions 1650 within strategic decision framework 1300. The first step of the process 1660 is to derive value drivers from the strategic position 1552. Value drivers may be derived from the positioning of the business 1660, on an historical, current or future basis, through mapping of sets of value drivers to positions in a strategic framework. Functions or algorithms may be applied to interpolate or extrapolate value drivers for positions not explicitly mapped to a discrete set of value drivers. In some embodiments, the algorithm applies a function that calibrates the value drivers based on the relative distance of the strategic position from the vertices of the strategic framework that are mapped to specific value drivers. The function may be linear or non-linear. The value drivers may have weighted values applied to denote the degree to which they apply to a specific strategic position. In addition, or alternatively, the value drivers may be ranked. In any case, the output of 1660 may be a vector of value drivers, which may constitute the set of all possible value drivers established in business lifecycle strategy and processes 1110, or a subset of the set of all value drivers. Further, the vector may contain numeric absolute or relative weightings associated with each included value driver. The strategic framework employed as input to the process step 1660 may be the StrategySpace framework 1500 or an alternative strategic framework.

The derived vector of value drivers from 1160 serve as input to the map derived value drivers to decision variables procedure 1670. The decision variables may include key decisions, uncertain variables, and information gathering options associated with the value driver vector. With the key decisions, uncertain variables, and information gathering options specified, the appropriate actions to be conducted are then determined 1680. The decision model 1310 and evaluation function 1320 may be applied by 1680 to choose the appropriate action or actions to take given the vector of value drivers.

FIG. 12C depicts an alternative, or additional, approach. FIG. 12C depicts a position 1552 on a strategic framework 1500 (or any other type of multidimensional strategic framework) used as input to a value driver to process mapping procedure 1655, which in turn deliver guidance on directions or actions associated with regard to one or more business processes of the business represented by position 1552.

FIG. 12D further depicts a flow associated with value driver to process mapping procedure 1655. As in the case of the procedure depicted in FIG. 12B, value drivers are derived from a strategic position 1660. The resulting vector of value drivers are used as an input to the map derived value drivers to processes procedure 1690. The mapping of value drivers to business processes 1690 may constitute a discrete set of correspondences, or a function or algorithm may be applied to interpolate or extrapolate as required between the vector of value drivers generated by 1160 and the set of all processes. The output of 1690 may be a vector of processes which may include the set of all processes associated with the business represented by position 1552, or a relevant subset of the set of all processes. The processes may have weighted values applied to denote the degree to which they map to the vector of value drivers. In addition, or alternatively, the processes may be ranked. Further, the vector of processes may contain numeric absolute or relative weightings associated with each included process.

The vector of processes generated from procedure 1690 is an input into the procedure for determining actions associated with process strategies 1695. The actions or directions generated by procedure 1695 may include determining which set of processes is most “core” to the business and therefore need special attention. The procedure 1695 may include comparing the level of criticality of a given process as derived from the vector of processes generated by procedure 1690 with an assessment of the current state of capability of the corresponding process. This comparison may provide guidance on specific process directions. For example, if a process is critical, but currently not competitively strong, it will merit extraordinary means for improvement. On the other hand, a currently strong process that is not critical may be a target for reduced investment levels or even divestiture.

In some embodiments, other businesses (e.g., competitors) may also be represented in the competitive dimensions and framework 1200 of FIGS. 12A and 12B. The strategic positions of these businesses, on an absolute basis or relative basis to the business represented by position 1552 may be used by procedure 1650 of FIG. 12B or procedure 1655 of FIG. 12D to generate their respective outputs of decisions or process directions.

Further, in some embodiments, procedure 1650 of FIG. 12B or procedure 1655 of FIG. 12D may apply the methods and systems disclosed in PCT Patent Application No. PCT/US05/001348, entitled “Generative Investment Process,” filed on Jan. 18, 2005, which is hereby incorporated by reference as if set forth in its entirety.

In some embodiments, procedure 1650 of FIG. 12B or the procedure 1655 of FIG. 12D may be implemented on a computer system and some or all of the corresponding procedure steps may be automatically conducted through software-based functions.

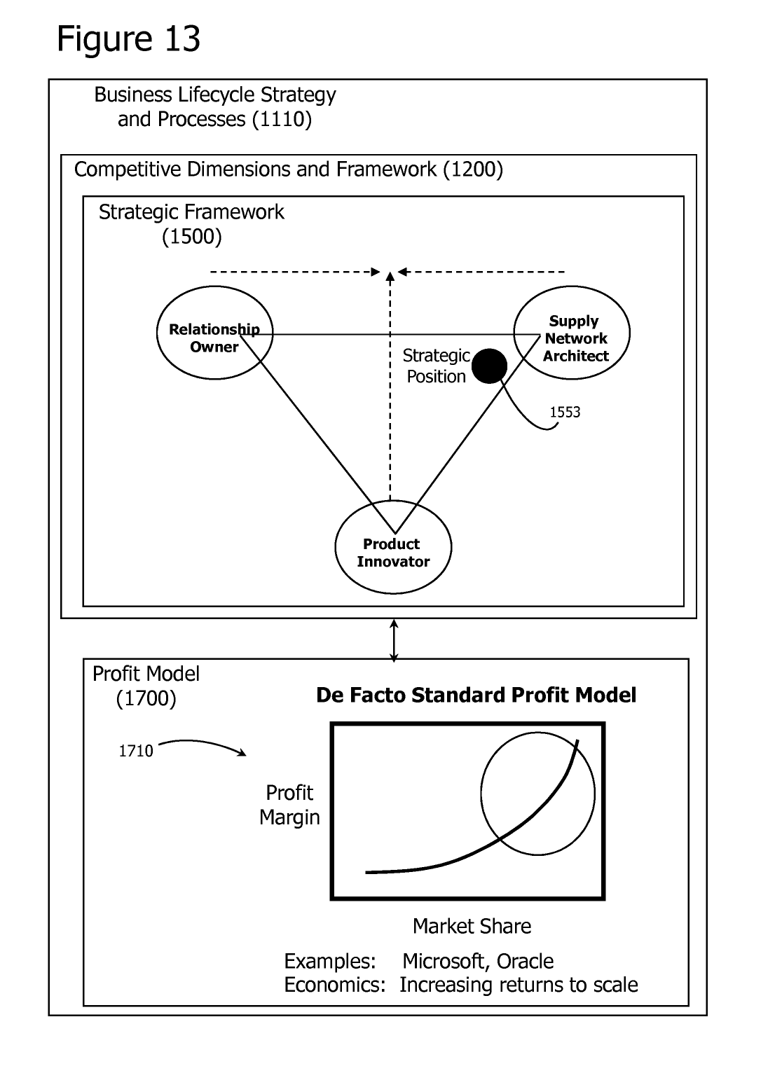

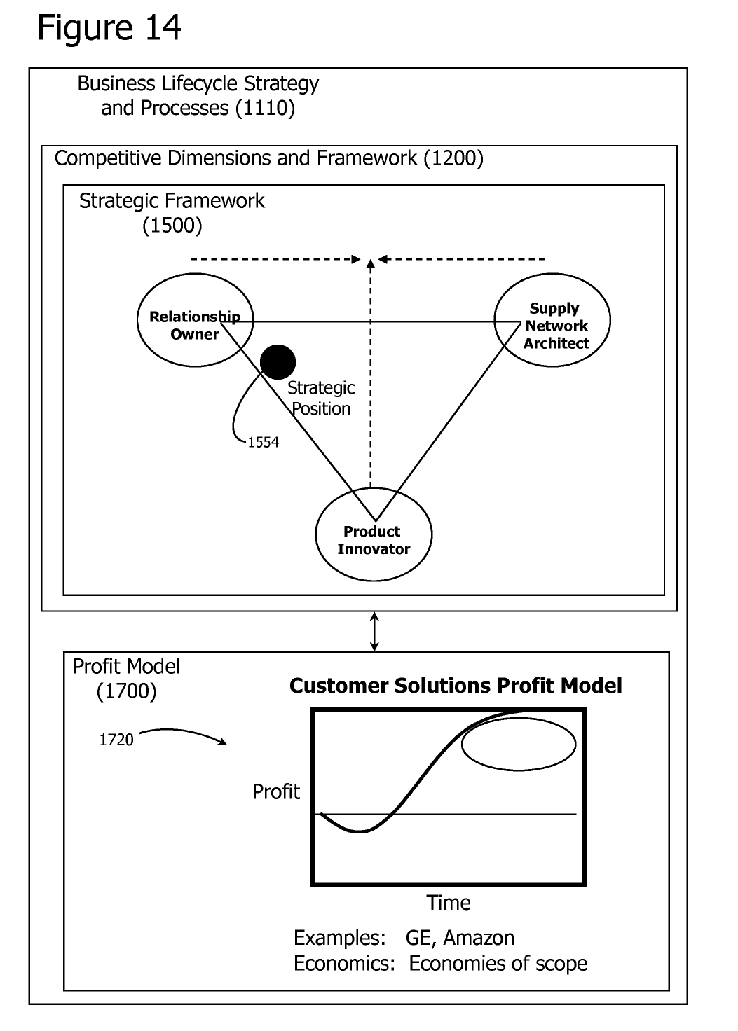

In some embodiments “profit models”, which may be of the forms as described in the book “Profit Zone” by Slywotzky, 1998, or any other alternative profit model form, may be mapped to strategic positions. Profit models constitute the basic economic approach that a business employs to create value. They are generally approaches that enable the business to gain a competitive advantage in the marketplace, and thereby generate above normal returns to owners and investors. FIGS. 13 and 14 provide two examples of the mapping of profit models to strategic positions. FIG. 13 illustrates a strategic position 1553 and a profit model 1700, including a specific instance or type of profit model 1710. The profit model type 1710 corresponds to strategic position 1553, and is a profit model based on high market share due to the establishment of a product standard. FIG. 14 illustrates a different strategic position 1554 and a corresponding profit model type 1720 based on achieving a high degree of product and service scope for a set of customers. In general, one or more profit model types may map to any given strategic framework, and one or more of the profit model types may correspond to specific regions of a strategic framework (e.g., strategic frameworks 1400 and 1500) within competitive dimensions and framework 1200. Profit models may be mapped to value drivers and/or processes in some embodiments, either directly or indirectly. In some embodiments, the mapping of profit models to strategic positions may be implemented on a computer system.

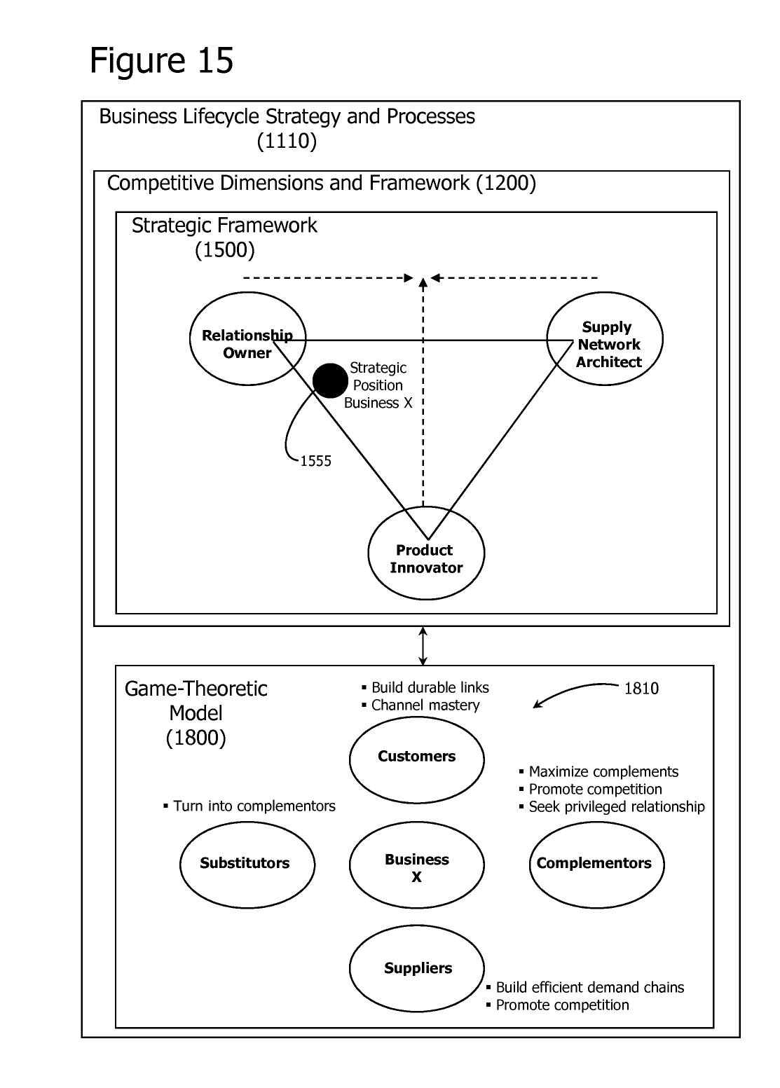

In some embodiments, strategic positioning may guide or be guided by game theoretic models 1800. FIG. 15 illustrates an example of one type of game theory model within the game theoretic model function 1800. The model type 1810 described is based on a game theoretic model described in the book “Competition”, by Brandenburger and Nalebuff, 1996, and can be employed to assess and determine business approaches toward other business entities. For a given business (“business X”), these business entities can be grouped into four categories: 1) customers (entities that purchase products or services from business X), suppliers (business X purchases product or services from the entities, complementors (entities whose providing of products or services to business X's customers enables business X to sell more of its products or services to these customers), and substitutors (entities whose providing of products or services to business X's customers results in business X to selling less of its products or services to these customers).

The specific approach to each of the members of this ecosystem of business entities may depend on the corresponding business' strategic positioning 1555. For example, some strategic positions may emphasize approaches for increasing complementary suppliers. Other strategic positions may emphasize maximizing the competition of suppliers.

In some embodiments, the alternative game theoretic model approaches may be derived automatically from a given strategic position 1555. In some embodiments, the game theoretic framework and approaches may guide the appropriate strategic positioning 1555 within competitive dimensions and framework 1200. In some embodiments, either or both of these approaches may be automated through implementation on a computer system.

### Industry Lifecycle Model

Understanding the dynamics of industry evolution can be of high importance for determining business strategy. Industry dynamics influence the value creation and capture opportunities presented to individual businesses. And each business should not be considered a passive participant in the evolution—rather it is a potential shaper of the evolutionary outcomes.

Industry evolution can be thought of as the simultaneous competition and cooperation of business strategies or approaches. The business strategies manifest themselves as individual businesses. Metaphorically, these “flesh and blood” businesses are the principal actors, but underneath, the “DNA” of businesses is the business strategy.

### Industry Evolution and the Industry Lifecycle Model

In accordance with some embodiments, an industry lifecycle model that can integrate with business strategic positioning is described.

Industries (and the constituent business strategies) can further be analogized to bodies in Newtonian physics—unless there is an external force applied, they move at constant velocity. Change generally only occurs when it is absolutely necessary.

In the absence of external forces or shocks, a period of stasis will occur with regard to the overall structure of the industry. Industry leadership may stay intact for decades in the absence of exogenous forces.

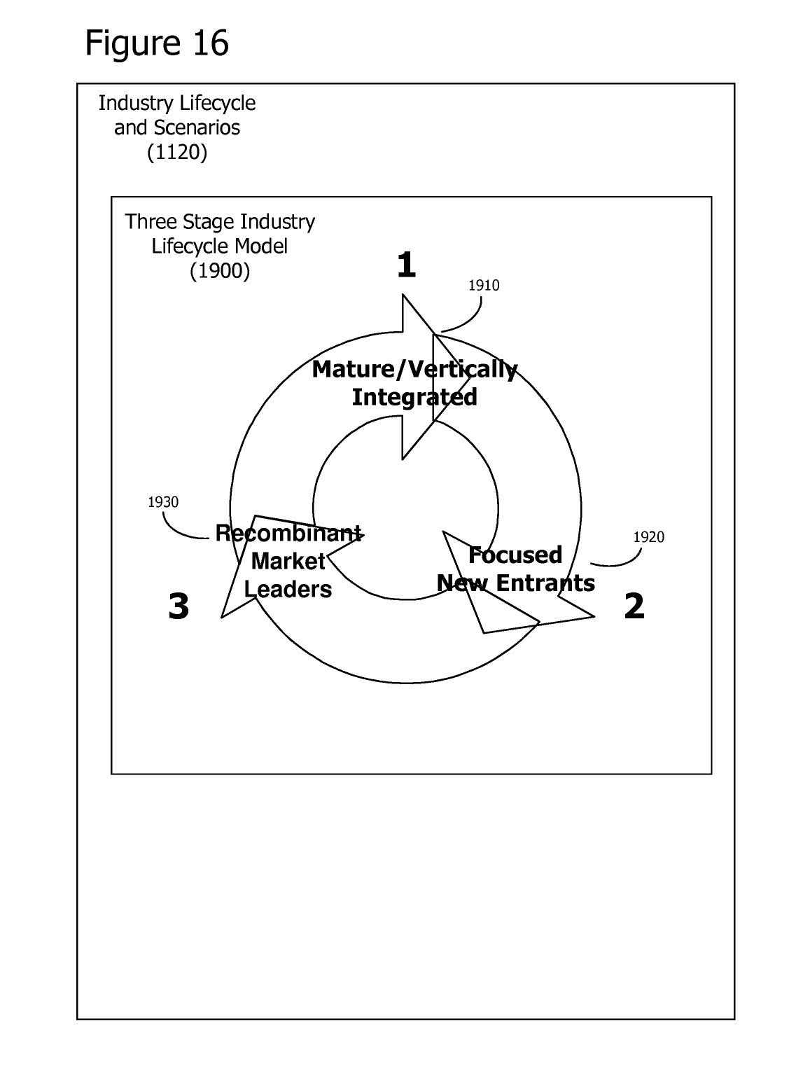

In accordance with some embodiments, FIG. 16 depicts an industry lifecycle model 1900 within the industry lifecycle and scenarios function 1120. Industries typically adhere to a three-stage cycle of evolution, as represented by the industry lifecycle model 1900. This model can also be termed the cycle of industry, “creative destruction”, after economist Joseph Schumpeter's colorful description of capitalism. It should be understood that although the term “industry” is used herein in describing industry lifecycle, it must be used advisedly, as the boundaries among industries can blur, and at the end of a cycle the “industry” may be virtually unrecognizable compared to its origins.

Fundamentally, this industry evolution is about the competition and resulting evolution of business strategies. In many ways companies can be thought of as “just” the vehicles for executing the competing business strategies (again, one can usefully analogize with biology—with the business strategies being analogous to genotypes, while the associated companies are analogous to phenotypes).

The cycle initiates with a period of stasis 1910—with relatively mature business strategies, often vertically integrated, and contributing adequate returns to investors. This period can be quite stable for a long time—the duration of the stability is a function of the emergence of significant marketplace continuities that serve to disrupt the mature business strategies.

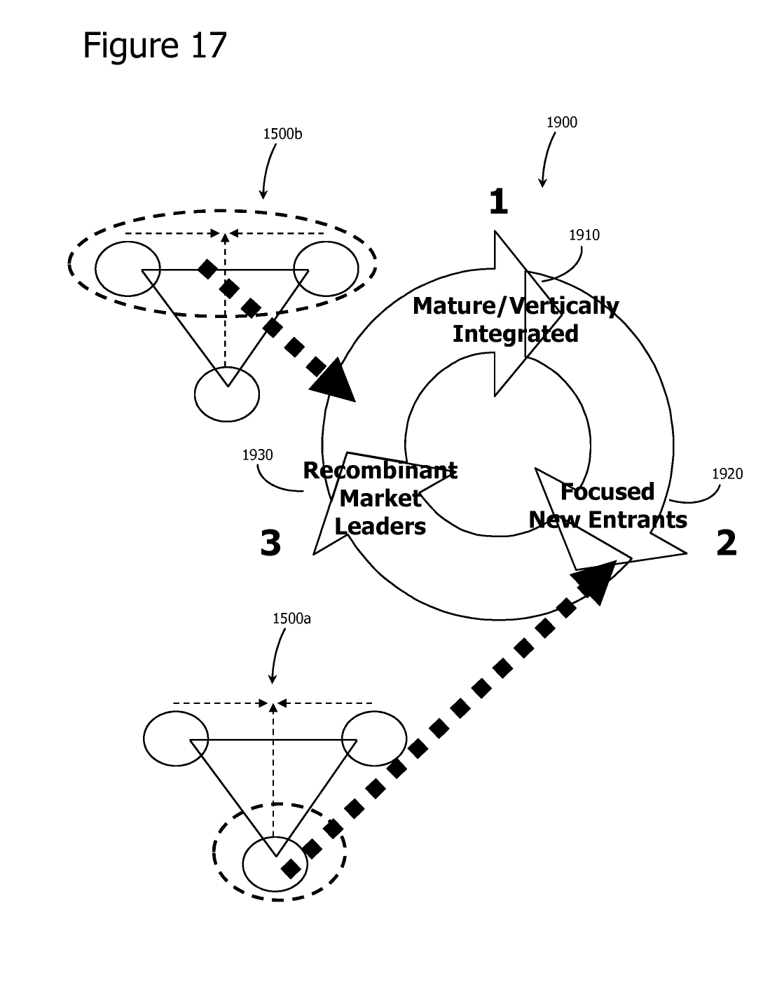

The disruptive discontinuities can be varied in nature, but the typical drivers are deregulation, new technologies, globalization, and shifts in consumer preferences. In accordance with some embodiments, as shown in FIG. 17, these discontinuities usher in the second stage of the industry evolution, as new business strategies 1500a (typically Product Innovators 1510) enter the industry, typically focusing on niche areas not adequately addressed by the existing business strategies. Initially, the incumbent industry leaders are typically slow to react to the new business strategies, as the size of the niches being exploited by the new models is not perceived to be sufficiently large to merit serious attention, or simply because the incumbents' current business strategies are not sufficiently adaptable to target these niches. But as this second stage 1920 develops, there is potential for the “niches” of the focused new entrants to begin to represent truly significant chunks of value of the industry (the profit zones), particularly as the original business strategies begin to struggle with the threat of commoditization (no-profit zones).

Further, as shown in FIG. 17, additional marketplace discontinuities may then usher in a third stage of industry evolution 1930, in which recombinant market leaders emerge. The term “recombinant” denotes a period of hybridization of business strategies. These strategies are more often of process driven strategies as depicted by strategy framework 1500b. In some cases, it is just a matter of the business strategies of some of the new entrants of the second stage continuing to grow, often fueled by acquisitions of companies represented by less successful business strategies, potentially to the point of becoming a new market leader. In other cases, some of the original market leaders in stage 1 1910 begin to “get it”—they understand the world is changing significantly and they must radically transform their current business strategy to survive. If these companies “get it” in time, while they still have significant financial resources that dwarf those of the new entrants, they may be able to successfully acquire a new business strategy and allow the acquired business strategy to replace the old model. Or it may be that the best of the new business strategy and the old model are combined in an innovative way that has advantages versus both the historic stage 1 competitors 1910 and the stage 2 upstarts 1920. These new market leaders, over time, become the mature businesses of stage 1 1910, with their own kind of “vertical” integration, and the cycle begins anew.

Although all industries evolve in a manner consistent with the creative destruction cycle, the pace of the cycle can differ dramatically—the actual pace of evolution being determined by the pace and magnitude of the disruptive discontinuities. For example, as will be highlighted in the following examples, the energy industry has taken decades to traverse a cycle, while the information technology cycle may occur within a decade or so.

### Industry Lifecycle Examples

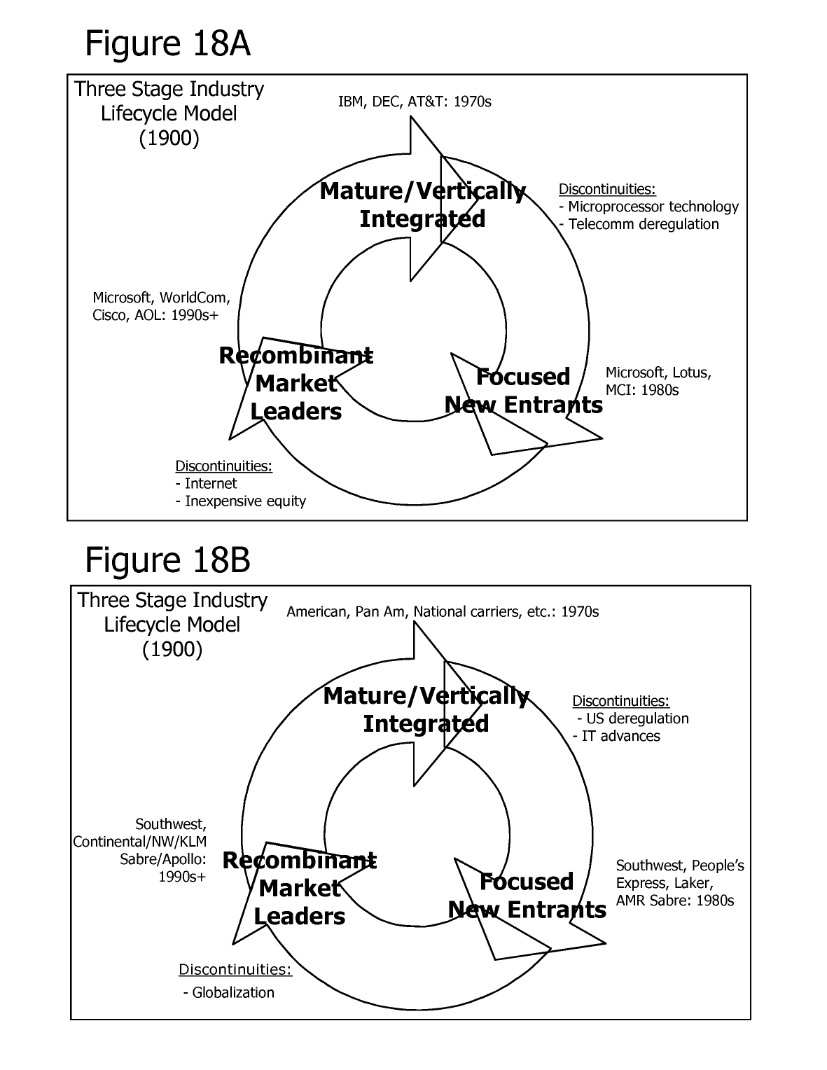

The first example of an application of industry lifecycle model 1900 relates to the fast-paced information technology and telecommunications industry (and this is a highly simplified sketch of a very complex industry) as depicted in FIG. 18A.

The example begins with the stage 1 of the 1970's and early 1980's. In the information technology space, the highly vertically integrated IBM dominated, with DEC (a new entrant of the previous cycle) being the other market leader. These companies combined everything from chip design and manufacturing, to operating systems, to applications software, to consulting services, all under one roof. In the telecommunications space, AT&T totally dominated (at least in the US).

In the early 1980's, two very disruptive discontinuities occurred: the introduction of microprocessor technology and deregulation of telecommunications and the break-up of AT&T. As a result, new entrants emerged. In information technology, by the mid-1980's, Microsoft, Lotus, and Oracle emerged as new entrants in the operating system and software space. Intel emerged as a significant force in microprocessors. And a little later, Novell emerged in the networking systems arena. On the telecommunications front, MCI, and later Sprint, emerged as new entrants in the long distance market.

As Stage 2 progressed into the 1990's, some of the new entrants' business strategies, particularly Microsoft's and Intel's, began to occupy huge value creating positions in the industry value chain, as microprocessor-based architectures displaced the previous technology regime.

By the mid-1990's, a second set of discontinuities began, which ushered in the stage 3. The first discontinuity was the advent of the Internet, a discontinuity that will ultimately, most likely be an order of magnitude more disruptive than the microprocessor revolution. The second discontinuity was inexpensive equity, as a result of the extraordinarily strong market for technology stocks—the inexpensive equity provided a tremendous acquisition currency and strongly encouraged the recombinant phase.

At the beginning of the 21^{st} century we are still generally in the midst of the recombinant phase, and it is instructive to review what is occurring. In some cases such as Microsoft and Intel, the new entrants of stage 2 have simply continued to ride their very robust business strategies with only minor changes. True, Microsoft has done some acquisitions, but they have not materially affected the business fundamental business strategy. In other cases such as Lotus, the stage 2 business strategy ran out of steam, and they were acquired by the stage 1 leader, IBM, that was seeking to adjust its business strategy (only partially successfully). MCI is an example of a successful stage 2 model being swallowed up by an even newer and, and for a short time, more successful entrant, WorldCom. And AT&T is an example of the stage 1 company that, after a change in leadership, at least partially “got it”, and worked to transform itself within 18 months from a laggard, to a company positioned for the upcoming broadband and wireless revolutions. This was only possible through aggressive acquisitions (and the blockbuster spin-off of Lucent). Meanwhile, the Internet revolution helped spawn a new set of leaders such as Cisco, America Online, Yahoo, and Amazon. In all of these cases, their inexpensive equity allowed them to consolidate and expand their positions extraordinarily quickly. Note again how industries blur as the cycle evolves: for example, by the end of the century, AOL and Yahoo where both technology and media companies.

Another example of the application of the industry lifecycle model 1900, as depicted in FIG. 18B, is the airline industry—an example of a more capital intensive industry.

In stage 1 of the cycle, a few large US airlines dominated, along with national carriers outside the United States. Stage 1 was stable for several decades—until the late 1970's. Then, Alfred Kahn deregulated the US airline industry. At the same time, a more subtle discontinuity, in the form of information technology advances, particularly in the area of database management and large-scale transaction processing, increased the capabilities of reservations systems.

These two discontinuities enabled new entrants to emerge, and phase 2 of the cycle to begin. Enabled by deregulation, a number of new entrants sought to employ a low cost model to attract a customer segment that had been previously neglected or under-served. These companies included Southwest Airlines, People's Express and Freddie Laker's trans-Atlantic airline, Laker Airways.

Also during this second stage, the value of owning the reservation system became much more important. AMR's (American Airlines' parent company) Sabre reservation system became the leader in this area. Over time, the reservations system became more valuable than the airline itself.

Spurred by globalization by the mid-1990's, the third stage had begun. Many of the earlier low cost models ultimately failed or were absorbed by larger companies. The notable exception was Southwest Airlines, which uniquely put all the required business strategy elements together to excel at the low cost game. And by this time, some of the stage 1 leaders had disappeared: Pan Am for example, and Eastern. The remaining airlines based on the hub and spoke operational model consolidated through outright acquisitions, or via alliances. The Continental/Northwest Airlines/KLM relationship was one such example. American Airlines and United Airlines anchored other sets of global alliances. Another interesting feature that evolved during stage 3 was the separation of the highly valuable IT-related operations from the airlines themselves.

So for example, Sabre was spun off, and became a separate, publicly traded company (worth more than the airline portion of AMR). And its primary competitor, Apollo, owned by a consortium of airlines, was also a separate company.

### Industry Lifecycle Framework and Scenarios

As business strategy competition and complexity increase, the pace and dynamics of industry evolution increase as well. Although there are some common features of the evolution of industries in general, getting the details right prospectively can mean the difference between value creation and value destruction. The strategic frameworks of some embodiments of business lifecycle management, including the StrategySpace model 1500, can be applied to help provide detailed insights into the avenues of value creation in an industry, and for individual business strategies.

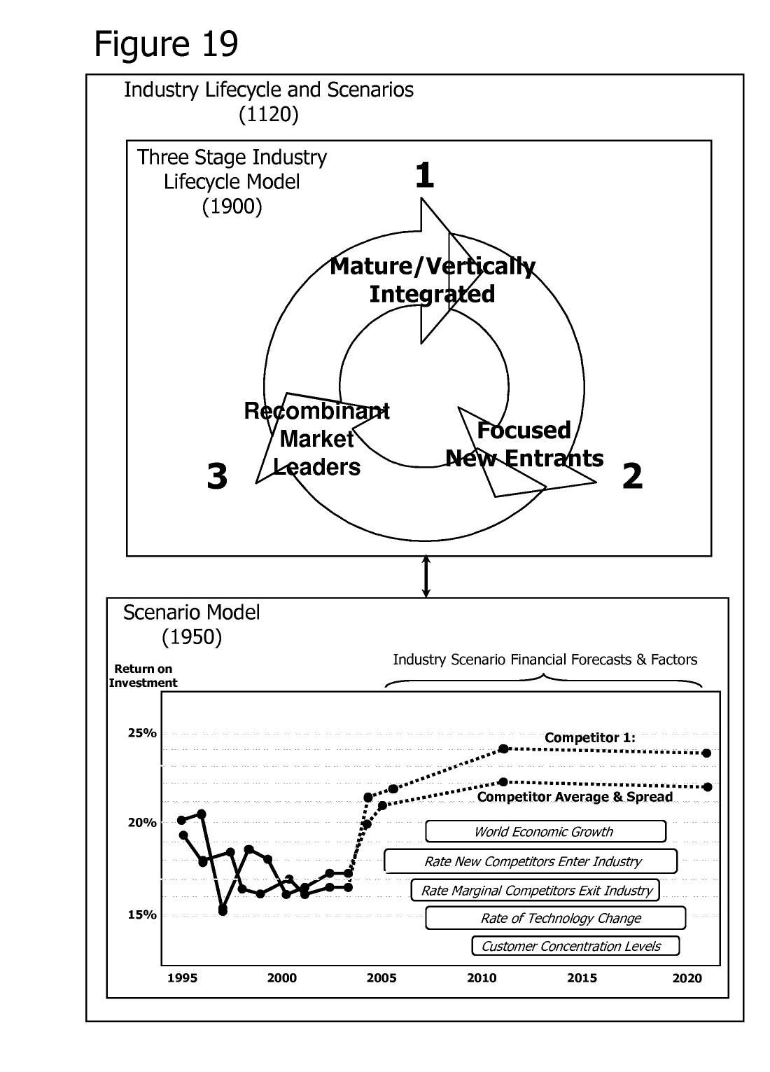

In some embodiments, as illustrated in FIG. 19, one or more scenarios within a scenario model 1950 may be developed through application of strategic frameworks, and the industry lifecycle model. The scenarios may specify the future course of a subject business, along with one or more other relevant businesses. The scenarios may include pro forma financial performance metrics, such as, but not limited to, revenue, profit, return on investment, return on capital, net present value, and market capitalization, associated with the subject business, and optionally for other relevant businesses. Alternative scenarios may be generated based on different assumptions related to specific businesses, the industry, or on a macroeconomic basis. In some embodiments, each scenario may include factors or “sign posts” that may be gauged as the future unfolds to assist in understanding with scenario or sets of scenarios the sign posts as consistent with, and to facilitate strategic decisions on a continuing basis.

In some embodiments, the scenarios may be generated automatically or semi-automatically based on strategic framework models, industry lifecycle models, auxiliary competitive and industry information, and/or scenario factors. Alternative assumptions are then input to enable generation of the scenarios.

### Product and Customer Lifecycle Strategies

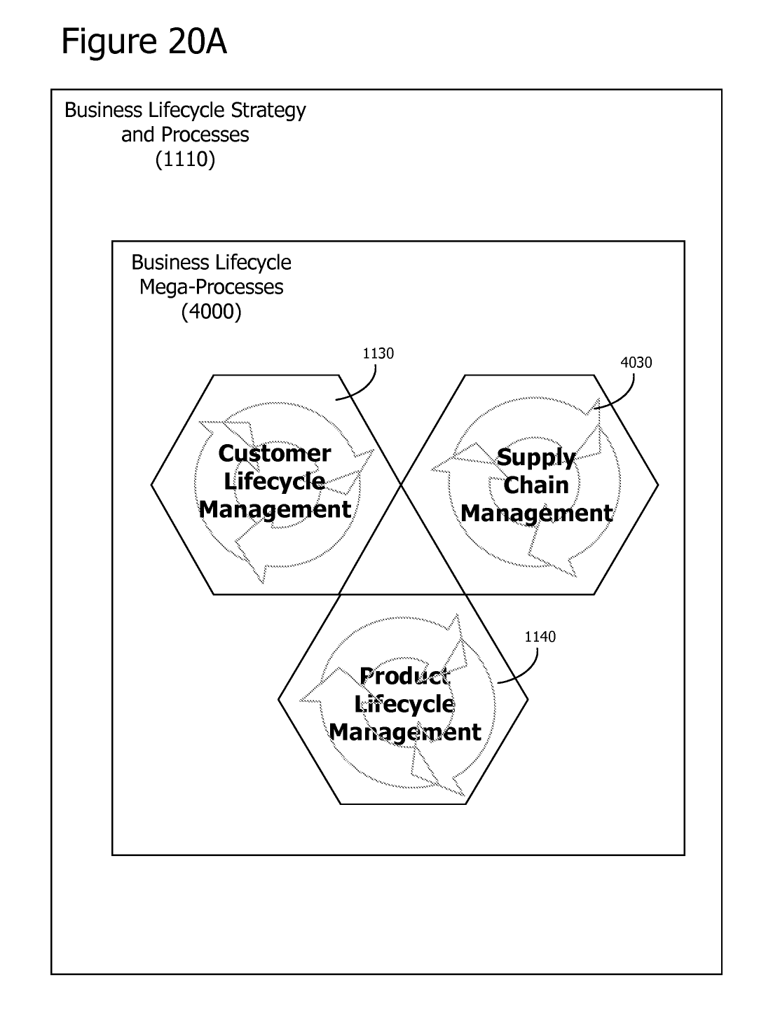

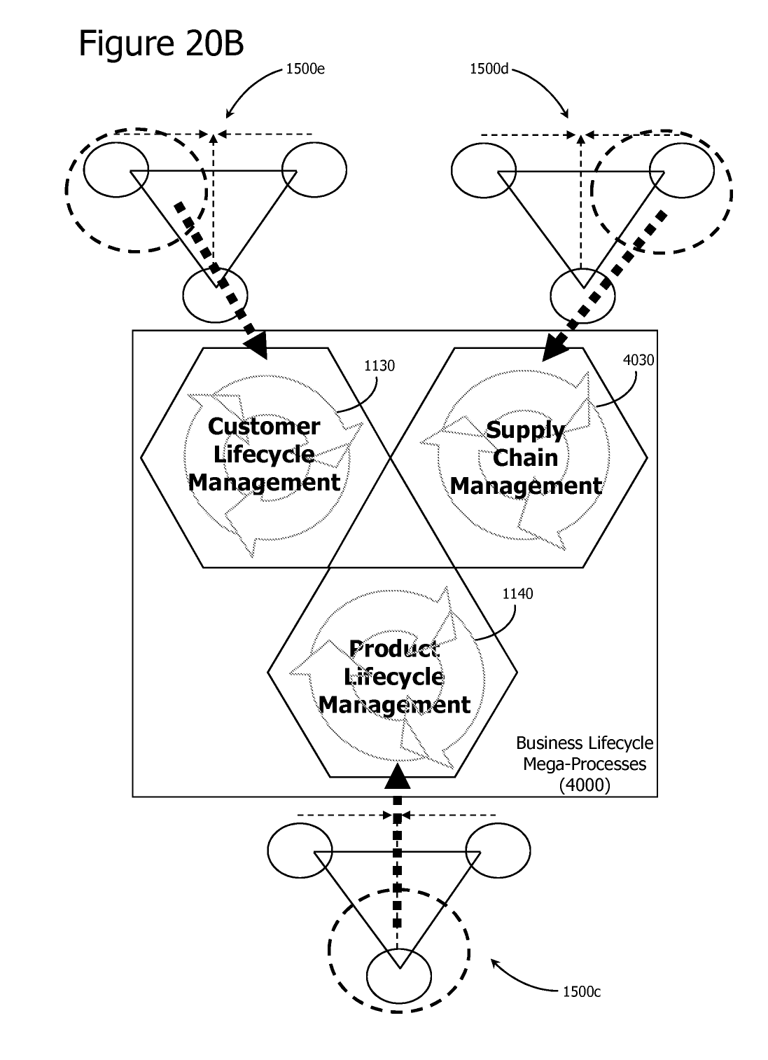

In accordance with some embodiments of business lifecycle management, FIG. 20A depicts the integration of the three “mega-processes” of a business, the customer lifecycle management process 1130, the product lifecycle management process 1140, and the supply chain management process 4030. The relative emphasis of each of these three mega-processes for a given business corresponds to the business' strategic position, as illustrated relative to the instances of the StrategySpace strategic frameworks 1500 in FIG. 20B. For example, the product lifecycle management mega-process will be of relatively the most importance to businesses that have a strategy oriented toward the product innovation position of the StrategySpace framework instance 1500c. The customer lifecycle management mega-process will be of relatively the most importance to businesses that have a strategy oriented toward the relationship owner position of the StrategySpace framework instance 1500e. And the supply chain management mega-process will be of relatively the most importance to businesses that have a strategy oriented toward the supply chain architect position of the StrategySpace framework instance 1500d.

Business renewal processes are processes that encompass activities, processes, and/or sub-processes related to strategies for, planning for, or executing on, the generation of new business (as opposed to maintaining existing business). New business may include new products or services, new customers or market segments, or combination thereof. Business renewal processes may therefore include, but are not limited to, activities or processes related to product or service development, solution development (where a solution is a combination of products and services) R&D, marketing, sales, relationship management, advertising and promotion, market and/or customer research, innovation processes, investment and/or budgeting processes, mergers and acquisitions, venture activities and processes, and growth strategies and processes.

Thus, business renewal strategies and processes 1050 of integrated business lifecycle management model 1000 include product lifecycle strategy 1140, customer lifecycle strategy 1130, and solution lifecycle process 1135. Although not explicitly depicted in FIG. 1, business renewal strategies and processes 1050 may also include other activities and processes consistent with the scope of business renewal as used herein.

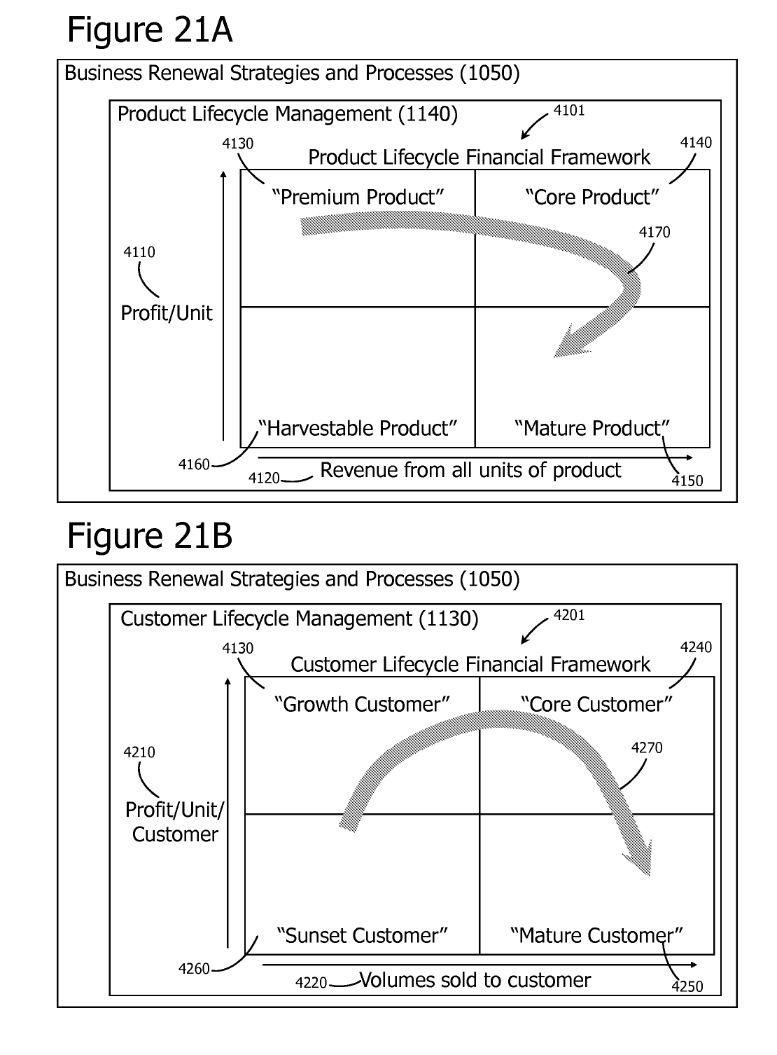

FIG. 21A depicts product lifecycle management and associated processes 1140, relating to the management of products or services from the standpoint of the supplier of the products or services, included within business renewal strategies and processes 1050. This includes the conception, the development, the commercial launch, the commercial management, and the retirement of the subject product. According to one embodiment of business lifecycle management, FIG. 21A depicts a framework for analyzing the financial performance of a businesses products and services from a lifecycle perspective, and establishing appropriate product lifecycle strategies.

Product lifecycle management and strategy process 1140 may include the application of the product lifecycle financial framework 4101. The product lifecycle financial framework 4101 includes two dimensions. The first dimension 4110 is the profit per unit of a product or service. Profit as used herein may imply before tax profit, after tax profit, contribution margin, or gross margin. In other words, the dimension 4110 is a financial metric that subtracts costs attributable to a particular product or service from the net price of the product or service. The second dimension 4120 measures the revenue from sales of the product. This dimension encompasses the volume of the product or service sold. This dimension may be on a logarithmic scale as the distribution of volume may obey a lognormal distribution or similar distribution that has a long “tail”.

The two dimensions 4110 and 4120 determine the four quadrants of product lifecycle financial framework 4101, although a continuum may alternatively be defined along the dimensions, rather than defining quadrants. The first quadrant 4130 includes products or services with high profit/unit, but low revenues. This quadrant may be termed “premium product”. The second quadrant 4140 includes products or services with high profit/unit and high revenues. This quadrant may be termed “core product”. The third quadrant 4150 includes products or services with low profit/unit, but high revenues. This quadrant may be termed “mature product”. The fourth quadrant 4160 includes products or services with low profit/unit and low revenues. This quadrant may be termed “mature product”.

A typical product lifecycle 4170 is shown within framework 4101. A product will typically begin in the premium product quadrant 4130 as it will have advantages versus existing products or services, but will have low market presence. Over time, if successful, it will migrate to the core product quadrant 4140 as the market awareness of its superior characteristics increases. Later, the product will tend to migrate to mature product quadrant 4150, as its profit/unit slips due to the availability of substitutes. In the worst case, it might migrate to harvestable product quadrant 4160 due to intensified competition and/or product obsolescence.

Each product or service may have its own historical and/or pro forma lifecycle path within framework 4101 that may or may not be similar to the archetypical product lifecycle path 4170.

Strategies may be applied to manage product or service lifecycle in alignment with their historical or expected lifecycle paths. For example, products in the premium product quadrant 4130 may deserve increased investment in associated marketing. Products in the core product quadrant 4140 are the stars of the business and should be continuously improved and defended against competition. Products in the mature product quadrant 4150 are often former stars that are on an inevitable decline, and may just need top be “milked” by minimizing investments in the products. Products in the harvestable product quadrant 4160 are a distraction and should be discontinued. These strategies are just particular examples—other product lifecycle strategies may be applied as appropriate.

Customer lifecycle management and associated processes 1130 relate to the management of customers from the standpoint of the supplier of products and/or services to the customer(s) or potential customers. This includes the acquisition, account build out, commercial management, and the potential “retirement” of the subject customer. According to one embodiment of business lifecycle management, FIG. 21B depicts a framework for analyzing the financial performance of a business' customers from a lifecycle perspective, and establishing appropriate customer lifecycle strategies.

Customer lifecycle strategy process 1130 may include the application of the customer lifecycle financial framework 4201. The customer lifecycle financial framework 4101 includes two dimensions. The first dimension 4210 is the profit generated from a customer per unit of product or service. Profit as used herein may imply before tax profit, after tax profit, contribution margin, or gross margin. In other words, the dimension 4210 is a financial metric that subtracts costs attributable to a particular customer from the net revenue generated by the customer, weighted on a volume basis by the particular product mix purchased by the customer. The second dimension 4220 measures the volume or number of units purchased by the customer. This dimension may be on a logarithmic scale as the distribution of volume may obey a lognormal distribution or similar distribution that has a long “tail”.

The two dimensions 4210 and 4220 determine the four quadrants of customer lifecycle financial framework 4201, although a continuum may be defined along the dimensions, rather than defining discrete quadrants. The first quadrant 4230 includes customers with high profit/unit, but low volumes. This quadrant may be termed “growth customer”. The second quadrant 4240 includes customers with high profit/unit and high volumes. This quadrant may be termed “core customer”. The third quadrant 4250 includes customers with low profit/unit, but high volumes. This quadrant may be termed “mature customer”. The fourth quadrant 4260 includes customers with low profit/unit and low volumes. This quadrant may be termed “sunset customer”. A typical customer lifecycle 4270 is shown within framework 4201. A customer will typically begin in the growth customer quadrant 4230 as it will purchase small volumes but at higher unit margins due to lack of purchasing leverage. Over time, if successfully managed, the customer will migrate to the core customer quadrant 4240 as the customer finds value in purchasing significantly greater volumes of products or services, but does not have access to meaningful substitutes. Over time the customer may tend to migrate to mature customer quadrant 4250, as its profit/unit slips due to the availability of substitutes. In the worst case, the customer might migrate to sunset customer quadrant 4260 due to intensified competition for the customer's business, or change in direction or preferences of the customer.

Each customer may have its own historical and/or pro forma lifecycle path within framework 4201 that may or may not be similar to the archetypical customer lifecycle path 4270.

Strategies may be applied to manage customer lifecycle in alignment with their historical or expected lifecycle paths. For example, customers in the growth customer quadrant 4230 may deserve increased investment in associated services, marketing, relationship management, etc. Customers in the core customer quadrant 4240 are critical to the performance of the business, and should be continuously invested in and defended against competition. Customers in the mature customer quadrant 4250 are often former core customers that view the products or services they are procuring as commodities. Either the products or services should be more differentiated to move the customer back to quadrant 4240, or the customer account should be effectively “milked” by minimizing investments in the customers. Customers in the sunset customer quadrant 4260 are a distraction and should be discontinued or handled through third parties that can aggregate such customers (e.g., distributors). These strategies are just particular examples—other customer lifecycle strategies may be applied as appropriate.

According to some embodiments, activity-based costing approaches or processes may be applied to generate the appropriate financial metrics associated with frameworks 4101 and 4201.

### Process Lifecycle Management

Processes are ubiquitous throughout the business world, and apply as well to non-business institutions such as government and non-profit organizations and institutions. In the following descriptions of processes and the application of business lifecycle management, business examples will typically be used, but it should be understood that the descriptions of processes and related features extends to non-business institutions and organizations.

Processes can be defined as categorizations of activities, along with associated inputs and outputs of the activities. A process may apply to, but is not limited to, the following general application areas: marketing, sales, price determination, innovation, research and development (R&D), product development, service and solutions development, business development, tangible or intangible asset management, manufacturing, supply chain management, logistics and transportation, procurement, finance and accounting, investment and portfolio management, human education, entertainment, information technology, security, legal, administrative processes and business strategy.

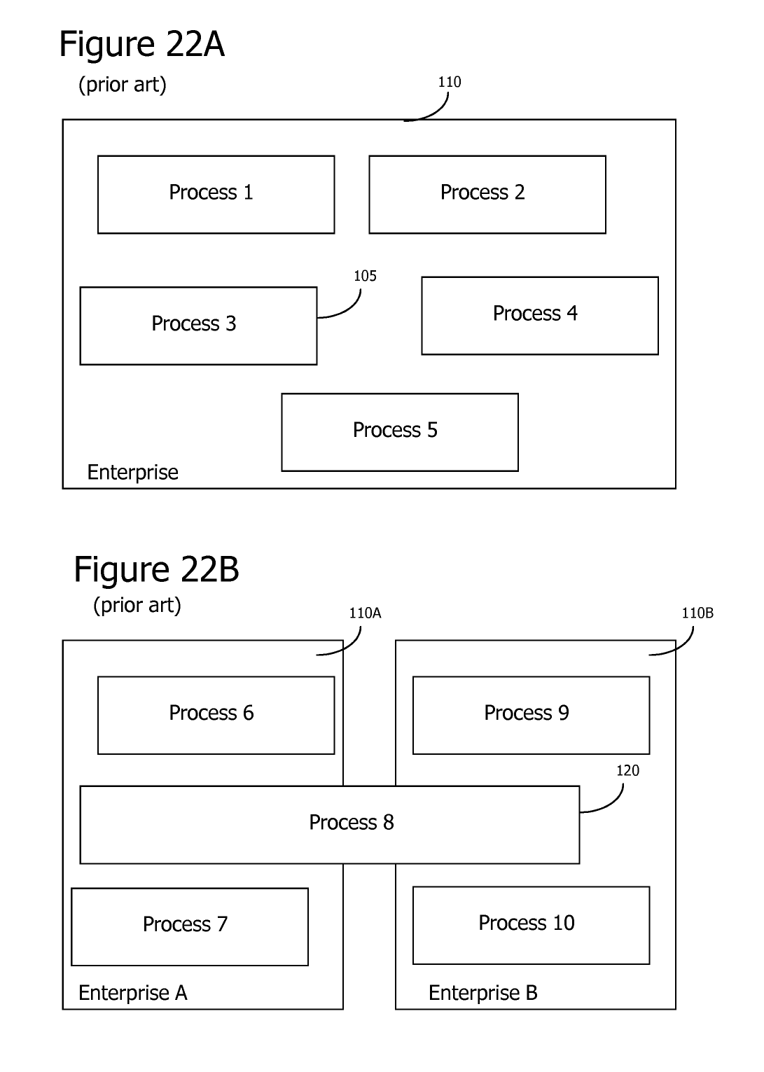

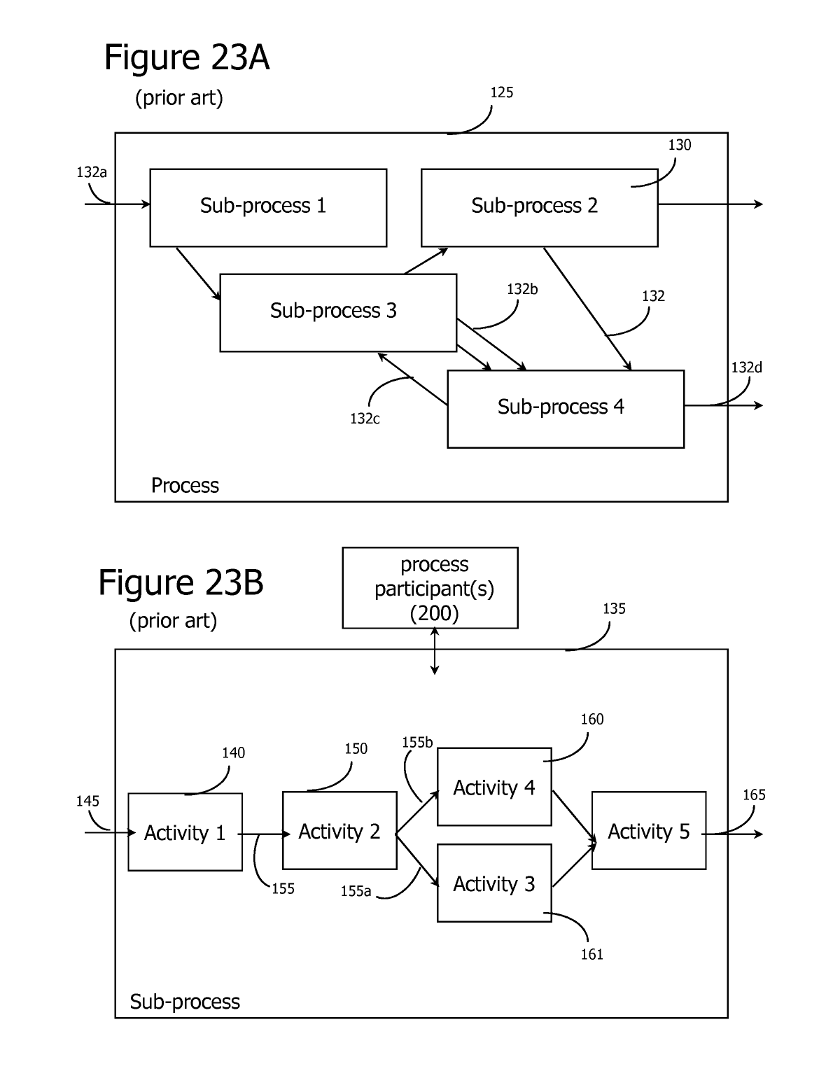

FIGS. 22A, 22B, 23A, 23B describe prior art and definitions associated with processes.

FIG. 22A depicts a business enterprise 110 including a plurality of processes, a specific example being “process 3” 105. A business may include one or more processes. It is a typical practice to determine a number of processes that can be effectively remembered and managed by people in the associated business—for example, seven processes (plus or minus two) is a commonly selected number of processes for an organization. Although not explicitly shown in FIG. 22A, each process may have one or more linkages to another process. The linkages may denote a workflow between the processes, or the linkage may denote an information flow, or a linkage may denote both workflow and information flow.

As depicted in FIG. 22B, processes may extend across businesses or enterprises, or most broadly, organizations. For example, in FIG. 22B, “Process 8” 120 is shown extending across “Enterprise A” 110A and “Enterprise B” 110B. It should be understood that, in general, multiple processes may extend across multiple enterprises or organizations.

FIG. 23A illustrates that each process 125 may include one or more sub-processes. As in the case of processes, sub-processes may have one or more directed linkages 132 to other sub-processes within the process, or to processes outside the process within which the sub-process exists. These external links may constitute inbound links 132a or outbound links 132d. There may exist a plurality of links between any two sub-processes, and the plurality of links may include inbound 132b or outbound links 132c. Although not explicitly shown in FIG. 23A, each sub-process may contain one or more other sub-processes, and this recursive decomposition of sub-processes can continue without limit. It should be noted, as defined herein, that the only essential distinguishing feature of a sub-process with regard to a process is that a sub-process is understood to be a subset of a process. Where the term sub-process is used herein, it is understood that the term process could be used without loss of generality.

FIG. 23B depicts a sub-process. A sub-process 135 is comprised of other sub-processes (not shown), and/or a series of activities, for example, “Activity 1” 140. These activities are conducted by process participants 200. In a business setting, each activity typically represents a unit of work to be conducted in a prescribed manner by one or more participants 200 in the process, and possibly according to a prescribed workflow. However, as defined herein, an activity may also simply constitute a process participant 200 action or behavior. For example, a process participant 200 for a sales process might be a prospective customer, and a behavior of the prospective customer may constitute an activity. In such cases a process participant, for example, a customer or prospective customer, may not be aware that their behaviors or interactions with a process constitute conducting a formally defined activity, although from the perspective of another process participant or the process owner, the activity may constitute a formally defined activity. Participants in a process 200, or “process participants,” are defined as individuals that perform some activity within a process, or otherwise interact with a process, or provide input to, or use the output from, a process or sub-process.

Although more than one activity is depicted in FIG. 23B, it should be understood that a process or sub-process may include only a single activity.

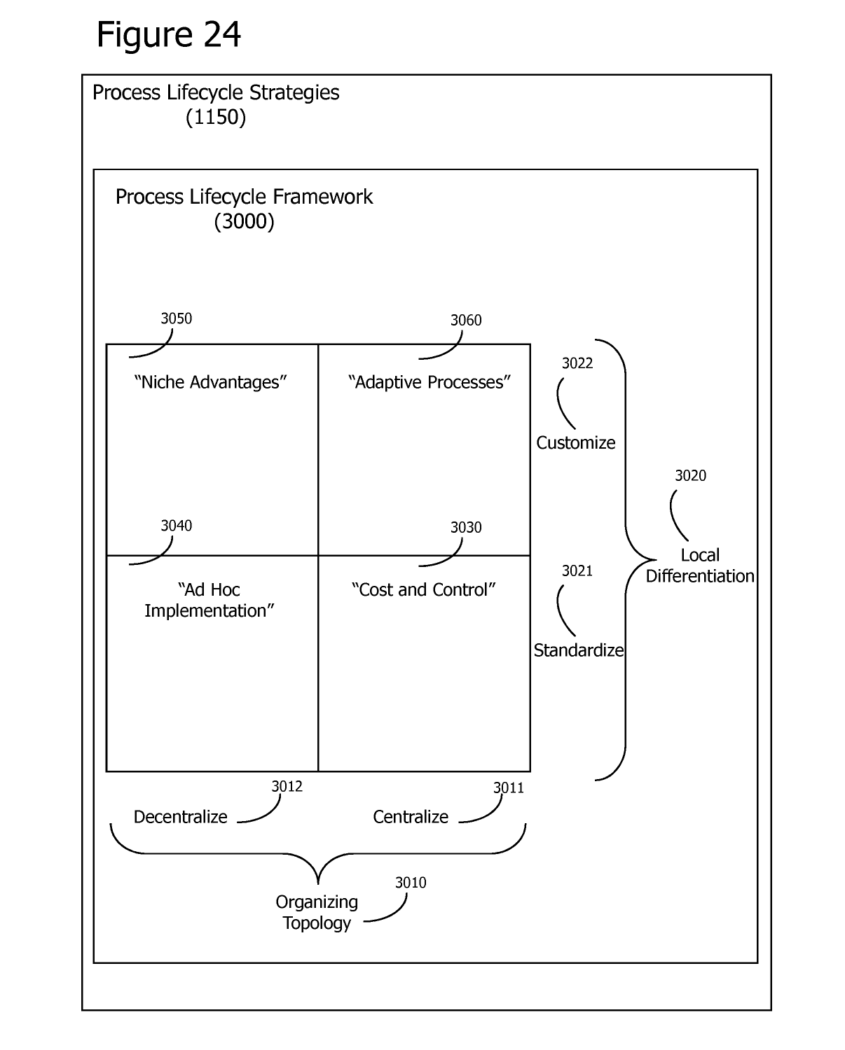

Any two activities may be linked, which implies a temporal sequencing or workflow, as for example the linkage 155 between “Activity 1” 140 and “Activity 2” 150. An activity may be cross-linked, back linked, or forward linked to more than one other activity. An activity may contain conditional decisions that determine which forward links to other activities, such as depicted by links 155a and 155b, are selected during execution of the antecedent activity 150. Parallel activities may exist as represented by “Activity 3” 161 and “Activity 4” 160. Inbound links 145 to activities of the sub-process 135 from other processes, sub-processes or activities may exist, as well as outbound links 165 from activities of the sub-process 135 to other processes, sub-processes, or activities. In some embodiments, as shown in FIG. 24, a process lifecycle framework 3000 included in process lifecycle strategies 1150 may be used as an implementation framework for migrating to adaptive processes, based on the implementation of business lifecycle management, or in conjunction with other business strategy methods and/or technologies.

Process lifecycle framework 3000 has two primary dimensions. The horizontal dimension denotes how the organizing topology 3010 of a process is managed—either in a centralized 3011 or decentralized 3012 manner. The vertical dimension relates to how differentiated or customized the process is for local applications or implementations 3020. The process may be standardized across all local applications 3021, or may be customized to local applications 3022. The intersections of these dimensions denote fundamental process lifecycle positions. For example, a centralized organizing topology, coupled with standardization of processes across local applications, may be called a “cost and control” quadrant 3030. The focus in this quadrant is typically to ensure low cost processes that enforce broad standards across organization and application areas. This is the typical architecture of prior art processes supported by Enterprise Resource Planning (ERP) software that are implemented on a true enterprise basis.

A decentralized organizing topology, coupled with standardization of processes across local applications, may be called the “ad hoc” quadrant 3040. The focus in this quadrant is to enforce broad standards across organization and application areas, but through a decentralized process management and infrastructure approach. This quadrant often represents an inconsistency of objectives, and may be the result of organizational combinations, such as through a merger or acquisition. It is typically desirable to not remain in this quadrant in the long-term as it generates more costs to deliver the same results as in the “cost and control” quadrant 3030.

A decentralized organizing topology, coupled with customization of processes across local applications, may be called the “Niche Advantages” quadrant 3050. The emphasis of this quadrant is to maximize the value of the process in specific application areas through a decentralized process management and infrastructure approach that enables maximum flexibility and tailoring to local needs. This quadrant represents a potentially high value, but also high cost approach. It is often consistent with the development of new processes that provide competitive advantages, where the generation of value from the processes overrides inefficiencies stemming from decentralized process management and heterogeneous enabling infrastructure. Over time, however, as competitive advantages potentially dissipate, the cost penalty associated with this quadrant may be too high compared to the derived benefits.

A centralized organizing topology, coupled with customization of processes across local applications, may be called the “Adaptive Processes” quadrant 3060. The emphasis of this quadrant is to maximize the value of the process in specific application areas, but through an efficient, centralized process management and infrastructure approach that enables maximum flexibility and tailoring to local needs. This quadrant represents a potentially high value and low cost approach, and provides advantages versus the other three quadrants.

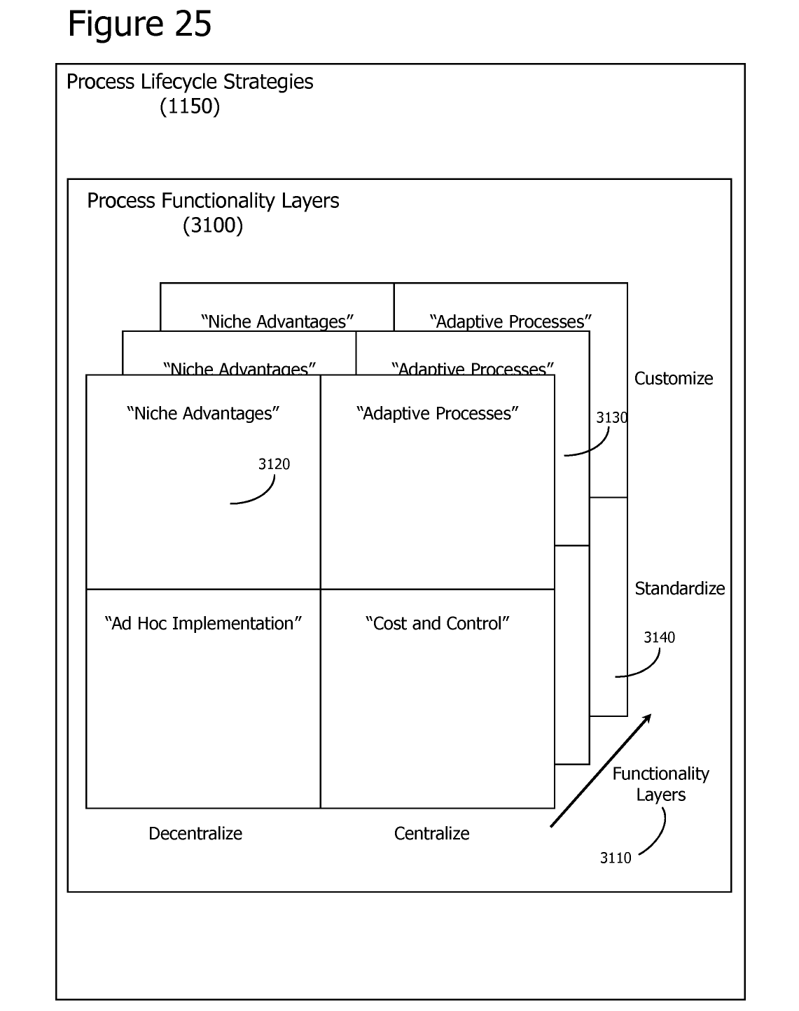

According to some embodiments, FIG. 25 is a framework 3100 that describes how processes are typically comprised of multiple functionality layers 3110. For example, these layers may comprise enabling information management and/or information technology layers, with the highest level corresponding to process work flow and business logic, and lower layers corresponding to more generalized information management and technology, such as knowledge management, content management, database management systems, and communications networks.

In a process implementation, then, different layers may have different process lifecycle quadrants. For example, the top-most layer may be a niche advantage quadrant 3120, the directly supporting layer may be an adaptive processes quadrant 3130, and the directly supporting layer of that layer may be a cost and control quadrant 3140. In general, it is good practice that the lower process layers should be at least as standardized as the layers above.

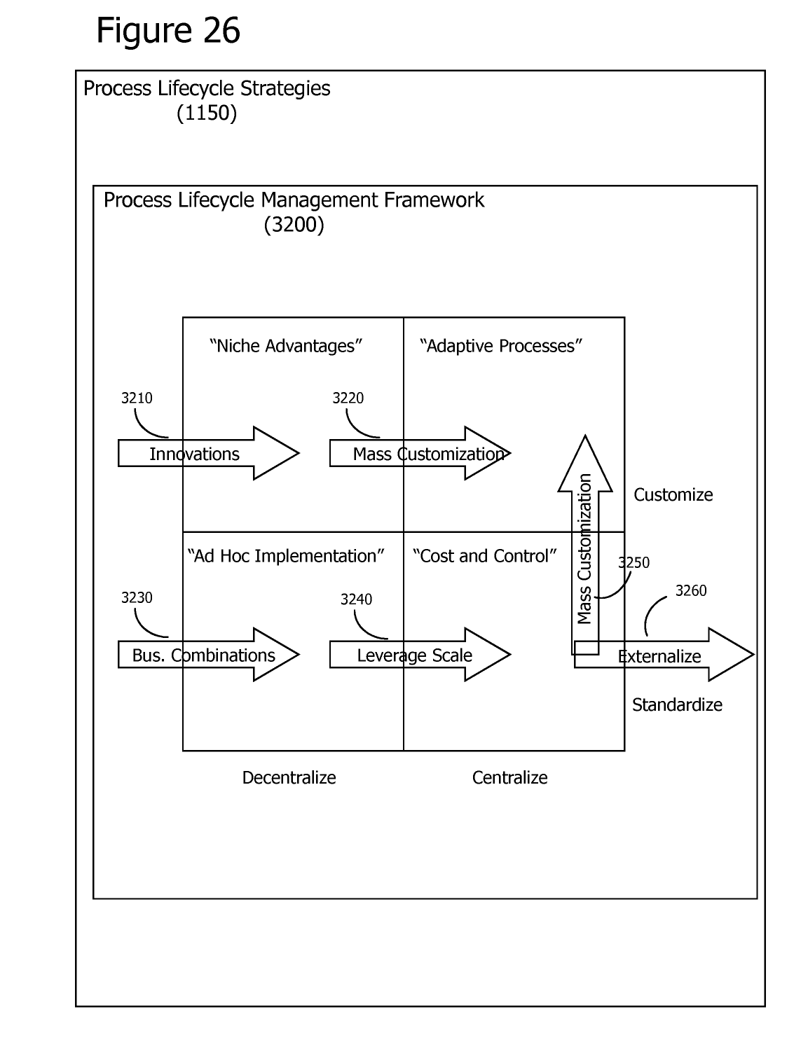

According to some embodiments, FIG. 26 represents a process lifecycle management framework 3200 that may be advantageously used by businesses and institutions to ensure the highest possible value from their processes over time. The framework 3200 may be understood to represent one specific process lifecycle functionality layer.

Business innovations 3210 may be the source of processes (or process functionality layers) in the Niche Advantages quadrant. Business combinations 3230 may be the source of processes in the Ad Hoc Implementation quadrants. It is usually advantageous to migrate from the Ad Hoc Implementation quadrant to the Cost and Control quadrant through more effective leverage of scale 3240. It may be advantageous to migrate from the Niche Advantages quadrant to the Adaptive Processes quadrant through leverage of mass customization techniques 3220. It may also be advantageous to migrate from the Cost and Control quadrant to the Adaptive Processes quadrant through leverage of mass customization techniques 3250. Alternatively, it may also be advantageous to externalize the process 3260 from the Cost and Control quadrant, where external sources can provide process advantages, typically either through cost effectiveness, or through more effective customization or adaptation to local applications and the same cost.

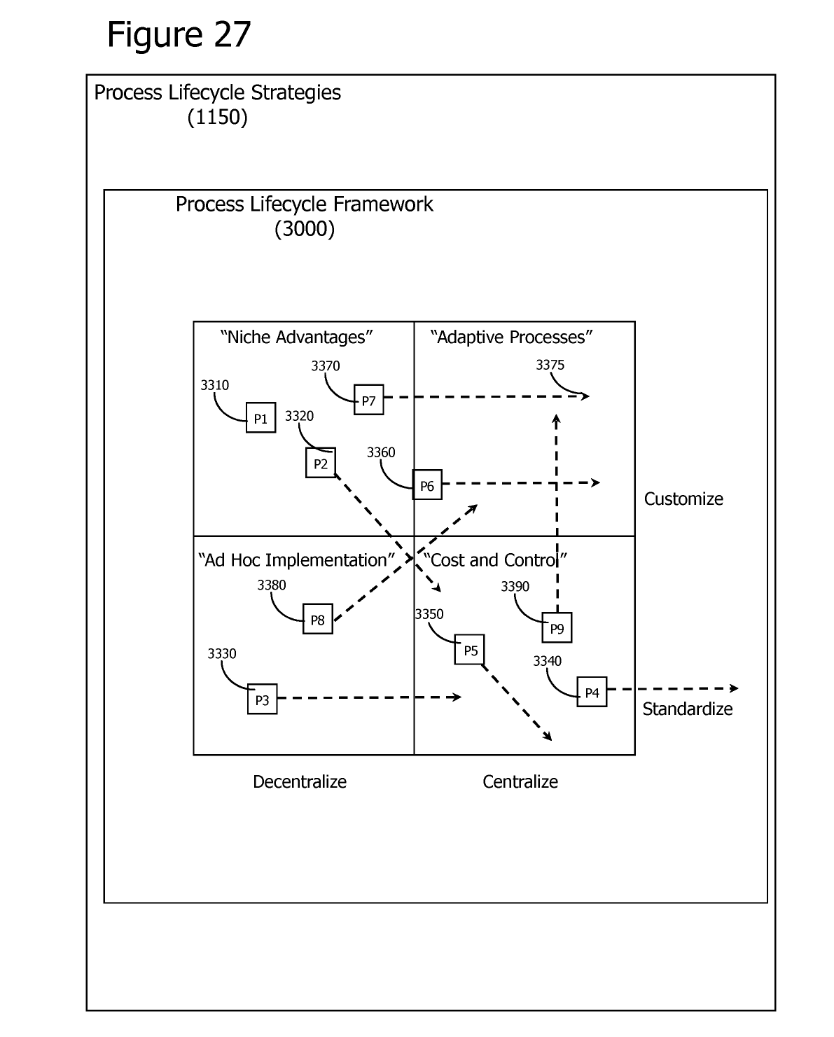

In accordance with some embodiments, FIG. 27 depicts an example of potential paths on the process lifecycle framework 3000. These paths may be in accordance with exemplary paths described by the process lifecycle management framework 3200 depicted in FIG. 26.

FIG. 27 illustrates the mapping of nine existing processes on the process lifecycle framework 3000, designated as “P1” 3310, for process 1, “P2” 3320 for process 2, and so on, to “P9” 3390. Each of the nine processes with an associated strategy that calls for the process to be repositioned has an associated arrow that indicates the desired future position of the process. For example, for process “P7” 3370, the desired future state is shown by the arrow head 3375 of the arrow associated with “P7” 3370. It should be noted that some processes may not require re-positioning. For example, process “P1” does not have an associated arrow, indicating its current position is best position for the future as well. It should also be noted that a process may be entirely externalized in the future, as exemplified by process “P4” 3340.

### Solution Lifecycle

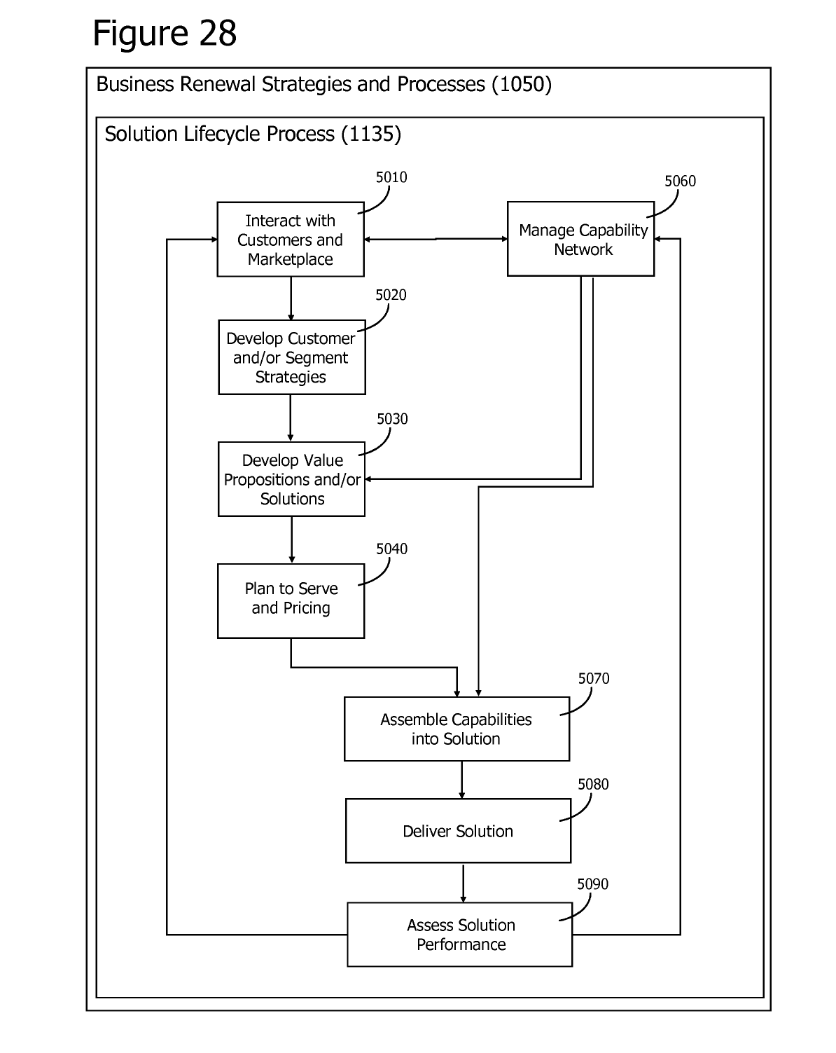

FIG. 28 describes another element, according to some embodiments, of the business renewal strategies and processes 1050—the solution lifecycle process 1135. The solution lifecycle process 1135 is comprised of sub-processes that collectively integrate customer or marketplace needs and requirements with capabilities, that when combined, constitute a solution aimed at fulfilling the customer or marketplace needs and requirement. The solution is then delivered to the customer and the performance of the solution is assessed. This assessment may then serve to help initiate another cycle of the overall solution lifecycle process 1135.

The solution lifecycle process 1135 may begin with a sub-process associated with interaction with customers and the marketplace 5010. This sub-process 5010 may include conducting market research, customer surveys, collaborative meetings or workshops with one or more customers. It may also include understanding relevant trends, including macro-economic factors, industry directions, customer directions, competitor directions, and technology trends. Further, potential discontinuities may be identified, including potentially fundamental shifts in consumer behavior, customer directions, competitor behavior, products and services, technologies, and business models.

With the information from sub-process 5010 as input, customer and/or market segment strategies may be developed 5020. The develop customer and/or segment strategies sub-process 5020 may include determining the value drivers of a customer or set of customers. The value drivers of a customer are the capabilities, processes, or activities that the customer expects will deliver true competitive advantages over the long-term. Understanding customer value drivers is therefore critical in understanding how to successfully position with a customer over the long-term. Different customers may have very different value drivers. For example, for some customers, a value driver may be the ability to differentiate product in the market place through brand awareness; for others it may be differentiated product performance; for others it may be managing channel partners more effectively; and for others it may be lowest product cost.

The develop customer and/or segment strategies sub-process 5020 may also include evaluating customer potential and fit. Customer potential can be assessed in financial terms, and is a combination of the value of currently projected business with the customer and the potential for additional business in the future. This potential business can also be termed “option value”, as a business has the option to pursue such opportunities with the customer, but not the obligation to do so. Both the currently projected business and the option value can be calculated by discounting expected after tax cash flows over a long-term horizon.

The develop customer and/or segment strategies sub-process 5020 may also include determining the desired overall positioning with a customer. This positioning can be thought of in terms of the overall relationship model with the customer, as measured across key dimensions. The relationship model must generally be collaboratively developed with the customer. The key dimensions or “views” with regard to customer integration or positioning may include:
1) Solutions View
2) Process View
3) Relationship View
4) Value Share View

These views are ordered as they are above because the order reflects the general chronology of putting a differentiation and integration strategy into practice. For example, a unique solutions must exist or be developed to have any chance of having a more integrated set of business processes with a customer, to have a more intimate relationship with the customer, and to have a more equitable sharing of value that is mutually created. In other words, the supplier has to have something unique that can add real value to the customer to earn the right to have conversations about more enduring and intimate relationships, win-win value sharing, etc. Each view spans a range of positions, from a minimal degree of integration with the customer to significant integration with the customer.

### Solutions View

A solution is a set of products, services and a particular relationship model that is delivered to a customer. The solution addresses an unfulfilled need of a customer, and therefore is valued by the customer, and should be unique from competitive offerings. Only if a solution adds true value to a customer, and the solution cannot be delivered by a competitor, can a business be assured of capturing a fair portion of the value the solution delivers to customers.

The solutions view ranges from commodity product to multi-customer solution to customer-specific solution to broad scope customer-specific solution. At the extreme of a non-integrative relationship with a customer, a commodity product is one in which there is nothing unique for the customer, and the product or service is not unique versus competitive offerings. Basically, this extreme is by definition not a solution. However, a commodity product or service can be an element of a solution.

The next stage of the solutions view is multi-customer solution. This is an offering that is unique versus competitive offerings, but is not unique to one customer. An example is a unique product that has patent protection. Where possible, this type of solution can be very profitable. In fact, it can be argued that if a business already has a successful and defendable multi-customer solution, then there is no need to move toward more customer-unique solutions, which only add complexity, and therefore cost. For example, we would not expect, say, Microsoft, to move toward customer-unique solutions because its multi-customer solutions (e.g., operating system and Office bundles) are so profitable and defendable. However, many businesses, perhaps most, find that their multi-customer solutions have insufficient barriers to prevent a trend toward commoditization, and a move toward customer-unique solutions becomes an imperative.

Finally, at the most integrative extreme of the solutions view, is a broad scope customer-specific solution.

### Process View

As described previously, process is a set of activities that generates a specified output. Every business operates processes, whether they are explicitly identified or are more implicit in nature. Processes can span organizations, including customers and suppliers. The process view is therefore another important element of overall positioning with a customer. In fact, the process view is often over-looked by businesses, and therefore represents a significant positioning opportunity versus competitors.

At the extreme of a non-integrative, non-adaptive relationship with a customer—one consistent with selling a commodity product or service—is a process position that is one of arms-length transactions. In other words, the only process interactions are at the level of the purchase transaction—invoicing, bills of lading, etc.

Moving to the next level of process integration is one of “connected processes”, consistent, for example, with supplying a solution (a unique offering versus competitors and potentially unique to a customer). A connected process approach implies that the output of one process seamlessly becomes the input to another process. For example, in a product development process, supplier test results might be packaged in a digital format compatible with the customer's product development systems and data management infrastructure, enabling a seamless hand-off of key information. Another example is a customer's demand forecasting information being automatically sent to the supplier's demand forecasting system.

Moving beyond connected processes, is a position termed “integrated processes”. This next level of process positioning can be illustrated by extending the examples above. For example, rather than handing off supplier test information to a customer, elements of the product development test processes might be merged. For example, identical test modeling software might be used by both the supplier and the customer. Or, in the case of demand forecasting, a single extended process, using a common forecasting platform might be used by both the customer and the supplier.

At the extreme of an integrative, adaptive relationship, is an opportunity for collaboratively managing strategic processes. A strategic process is a process that is critical to a customer and one whose performance provides true differentiation versus the customer's competitors. Collaborative management of the process means co-design and collaborative on-going operation of the process.

### Relationship View

Building on the solutions and process positioning, an appropriate relationship position can be developed. Consistent with the extreme of selling a customer a non-differentiated product or service, is a relationship that is based on the traditional customer/supplier relation. This is a relationship in which all of the power lies with the customer, as the customer has no incentive to maintain only one supplier on a sustained basis.

Progressing to the next level of relationship is one of “customer/unique supplier”. This is a relationship in which the power is more equally distributed as the supplier delivers a product or service that the customer cannot obtain elsewhere. Nevertheless, the customer may decide to simply do without the product or service.

At the next level of relationship is an “enduring collaboration”. This position is what is often loosely meant by the term “partnership”. At this stage the unique value the supplier brings the customer and vice versa is acknowledged and embodied as a mutual long-term commitment in a targeted area of the customer's business. The final stage of relationship is one of “strategic intimacy”, in which the scope of enduring collaboration is expanded to the point that the supplier becomes strategic to the customer, and the customer is strategic to the supplier. The supplier and customer's futures therefore become intertwined to the point of jointly developing strategic-level directions.

### Value Share View

The final view of the level of the relationship with the customer relates to the sharing of value between the customer and the supplier. Consistent with the extreme of selling a commodity product, is “market pricing”. And for commodities, market prices become driven down to the marginal cost of producing the product or service. Only if a supplier has a significant cost advantage versus competitors can the supplier of a commodity product or service achieve an adequate return.

At the next level of relationship, is the value share position of “fair negotiation”. By virtue of the uniqueness of the product or service versus competitors, the supplier can capture more of the value created by the solution. However, since multiple customers may purchase the same solution, the magnitude of the value created by the solution may be limited compared to solutions that are unique to a customer.

Consistent with a customer-specific solution and a relationship characterized by enduring collaboration is a value share position of “transparent win-win”. At this position, both the supplier and the customer recognize the importance to each other on a sustained basis, and therefore have an incentive for each to be successful. Hence sufficient transparency can exist between the supplier and customer to enable them to engineer a win-win relationship on a long-term basis.

At the most integrated and aligned extreme of value share positioning is “long-term shared risk/reward”. This position acknowledges the intertwining of the supplier's and the customer's futures, and aligns both the rewards and the risks associated with their mutual long-term strategy.

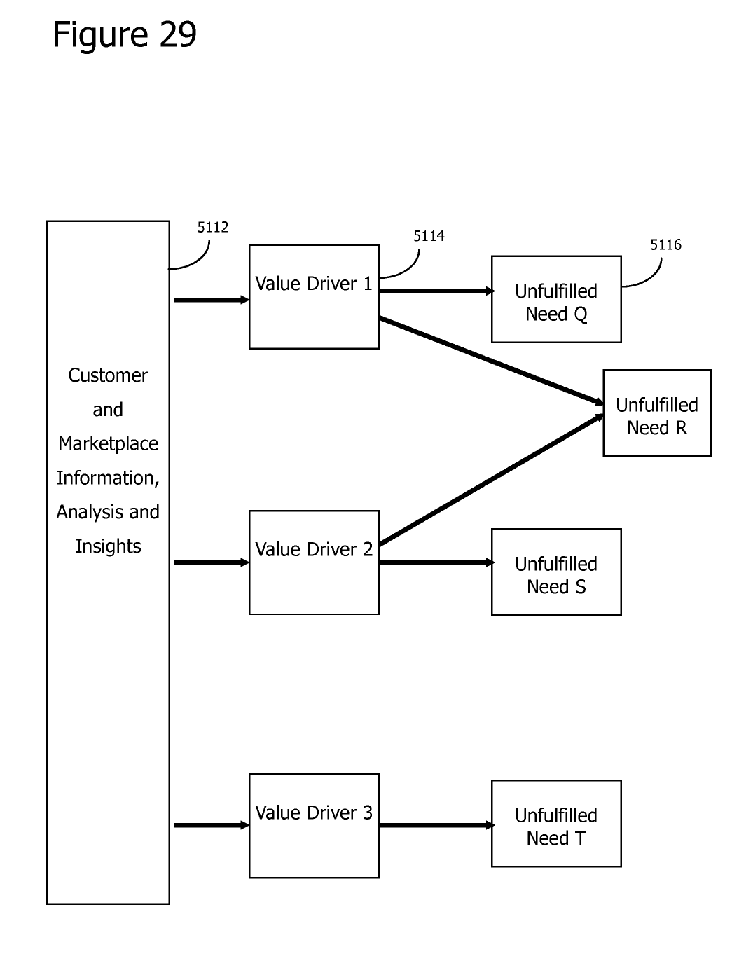

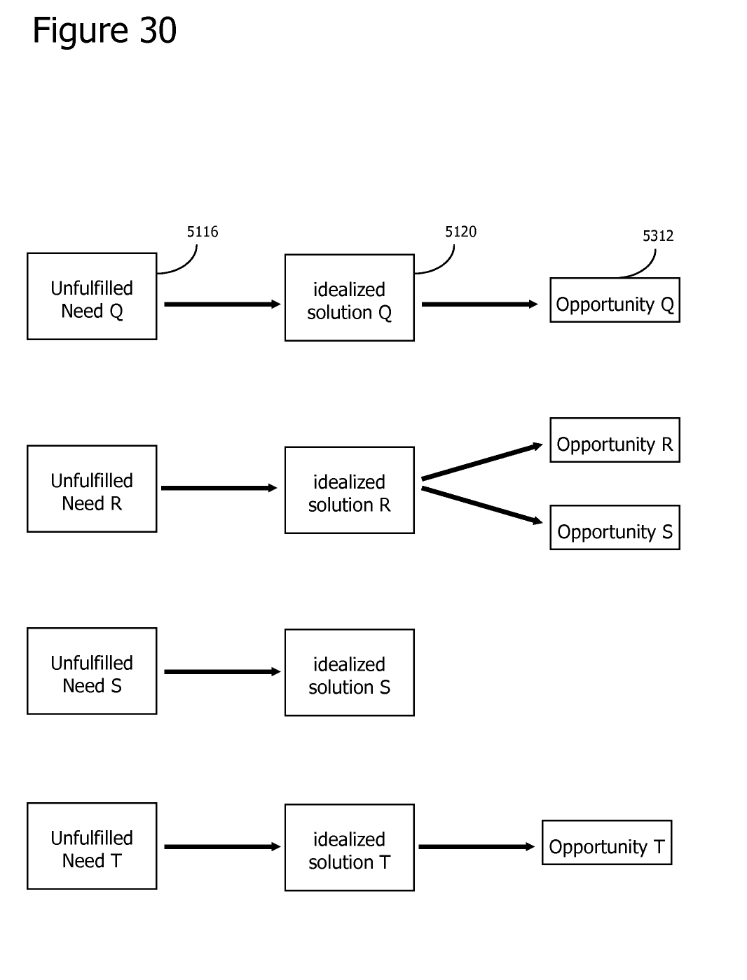

Returning to FIG. 28, applying the output from customer of segment strategies from sub-process 5020 as input, value propositions and/or solutions may be developed 5030. This sub-process focuses on the demand side of the solution equation—in particular customer and market-place needs. This sub-process combines interactions with customers and potential customers with analysis of the overall marketplace, including competitor offerings. The sub-process culminates with the development of idealized solutions or value propositions that, if possible to deliver to the customer, would be of high value to the customer and command significant economic rewards for the business. Key steps of this sub-process 5030 include:
1. Determine and shape unfulfilled needs
2. Generate idealized solutions to fulfill customer needs
3. Assess the expected value of idealized solutions
   The descriptions below associated with FIGS. 29 and 30 will provide further details associated with this sub-process.

With the value propositions and/or solutions from sub-process 5030 as input, a plan to serve the customer and associated pricing may be developed 5040. This sub-process 5040 focuses on determining whether a set of capabilities can be assembled to fulfill and idealized solution, and if so, what the solution delivery model would look like. In other words, it addresses what organization would need to do what in order to operationalize delivery of the solution. Once a viable delivery model has been determined (but not necessarily operationalized), an expected price of the solution can be determined, and expected financial returns analyzed. A go/no-go decision on pursuing the solution can be subsequently made. This sub-process 5040 may also include activities associated with marketing the solution to the customer(s). Key steps of this sub-process 5040 include:
1. Determine capabilities to deliver solution
2. Determine solution delivery model
3. Determine pricing of solution and conduct financial analysis

Prior to, subsequent to, or more typically, concurrently with the execution of sub-processes 5010, 5020, 5030, and/or 5040, a manage capability network sub-process 5060 is performed. This sub-process 5060 is the heart of the supply side of the solution equation. The sub-process 5060 hinges on the identification and management of capabilities required for solution development and delivery. Capabilities include products, services, technologies, physical assets, intellectual property, and relationships. Management of capabilities includes understanding those capabilities, whether internal or external to the business, that are most critical to enabling the business' portfolio of solutions, and establishing strategies to develop and continuously improve these capabilities. Importantly, privileged relationships with core external capabilities may be established during the performance of this sub-process 5060. An objective of this sub-process 5060 is to provide the business with continuous information advantages that can be translated into financial rewards through, for example, the transformation of the information advantages into privileged relationships, IP, etc. Key steps of sub-process 5060 include:
1. Evaluate internal and external capabilities
2. Identify core capabilities for solution delivery
3. Identify high leverage capabilities across the solution portfolio
4. Maintain or develop core internal capabilities
5. Develop privileged relationships with core external capabilities
6. Create informational and intellectual property advantages

Output from the manage capability network sub-process 5060 may serve as input to any of the “demand side” sub-processes 5010, 5020, 5030, or 5040. Further, output from any of the demand side sub-processes 5010, 5020, 5030, or 5040 may serve as input to sub-process 5060.

According to some embodiments, FIGS. 29 and 30 provide additional details associated with sub-processes 5010, 5020, 5030, 5040, and or 5060 of FIG. 28. In FIG. 29, information about customers and the marketplace is gathered, associated analysis is conducted, and insights are derived 5112. The information gathering may take the form of customer focus groups, customer and market surveys, evaluation of customer buying habits, evaluation of customer information access habits, general business intelligence, determining the directions and likely requirements of the customers of potential customers, general marketplace trends, general economic trends, and technology trends and futures.

The value drivers 5114 of one or more customers are derived based on the analysis and insights 5112. Value drivers 5114 are those set of activities, assets or processes that can deliver differentiated financial performance relative to the financial performance of a competitor, over time. By definition, improvement in value driver performance has value for a company. Value drivers 5114 may be specific to a customer or potential customer, or a single value driver 5114 may span multiple customers. In FIG. 29, the customer and marketplace information, analysis, and insights 5112 determine three value drivers 5114, value driver 1, value driver 2, and value driver 3.

Also depicted in FIG. 29 are unfulfilled needs 5116. Unfulfilled (or under-fulfilled) needs may be defined for each of the value drivers 5114. Unfulfilled needs 5116 are needs that are not currently being met, or are incompletely met, by current suppliers. Or, unfulfilled needs 5116 may be anticipated future needs that are expected not to be met or incompletely met by any future supplier, current or potential. In FIG. 29, unfulfilled needs Q and R are associated with value driver 1, unfulfilled needs R and S are associated with value driver 2, and unfulfilled need T is associated with value driver 3. Unfulfilled need R is simultaneously associated with value drivers 1 and 2. Although FIG. 29 depicts unfulfilled needs 5116 being derived directly from value drivers 5114, and indirectly from customer and marketplace information, analysis, and insights 5112, the unfulfilled needs 5116 may alternatively be directly derived from customer and marketplace information, analysis, and insights 5112, in some embodiments.

In FIG. 30, the unfulfilled needs 5116 from FIG. 29 are used to directly or indirectly generate opportunities 312. One or more idealized solutions 5120 may be generated to address each unfulfilled need 5116. An idealized solution may be defined as a set of capabilities that collectively constitute a solution that could be expected to effectively address some or all of the associated unfulfilled need. Each idealized solution 5120 may include one or more capability components 5316, which may or may not be capability components already under consideration. None, one, or more business opportunities 5312 may be generated in association with each of the idealized solutions 120.

Thus, the generation of opportunities 5312 through derivation of idealized solutions 5120 associated with unfulfilled customer needs 116 may be applied by business lifecycle management.

In some embodiments, sub-processes 5010, 5020, 5030, 5040, and or 5060 of FIG. 28, and procedures described by FIGS. 29 and 30 may use or apply the methods and systems disclosed in PCT Patent Application No. PCT/US05/001348, entitled “Generative Investment Process.”

Returning to FIG. 28, the output from the plan to serve and pricing sub-process 5040 and the output manage capability network 5060 are combined by the assemble capabilities into a solution sub-process 5070. The sub-process 5070 encompasses transforming the potential solution into a real solution that can be delivered to the customer. The preferred capabilities to be applied in developing and operationalizing the solution are determined, along with the preferred delivery model. Relationships and agreements with core external capabilities are established. The solution is assembled and tested. The solution may be proto-typed as required. Key steps of sub-process 5070 include:
1. Determine preferred capabilities for solution
2. Determine preferred solution delivery model
3. Create solution-specific relationships with core capabilities
4. Assemble solution and test

After assembling capabilities into one or more solutions 5070, the solution is delivered to one or more customers 5080. The sub-process 5080 is thus the step in which the solution is actually delivered to the customer for the first time. The sub-process includes planning for the launch of the solution, and then launching the solution to one or more customers.

After the solution has been delivered to the customer 5080, the performance of the solution may be assessed 5090. During this sub-process 5090, the initial assessment may be from the perspective of the customer e.g., is the solution delivering the value to the customer that was expected? How can the solution be improved? The second part of the assessment is from the perspective of the supplying business—e.g., what is the financial performance of the solution? How can the solution be improved?

The results of assessing the performance of a solution 5090 may in turn serve as input to sub-processes 5010 or 5060. Thus, the solution lifecycle process 1135 is a closed loop process.

### Knowledge and Content Lifecycle Process Management

Recall from FIG. 1 that knowledge and content lifecycle strategy 1160 interacts with process lifecycle strategies 1150. In addition, or alternatively, knowledge and content lifecycle strategy 1160 may be guided directly by business lifecycle strategy and processes 1110, or knowledge and content lifecycle strategy 1160 may be applied independently.

Knowledge management, content management, learning processes and communications are all related concepts, and all important to business performance. Communications—the transmission and receipt of information, knowledge or content—underpins most of human affairs.

An important advance in understanding the basic nature of communications was Claude Shannon's 1948 invention of information theory. At its heart, Shannon's theory addresses the very fundamental issue of communicating effectively in “noisy” environments. In other words, the theory is centered on ensuring the receipt of signal through a noisy communications channel. Shannon's insights can be extended to today's overall information or knowledge management environment—an environment characterized by a vast supply of information. For most recipients, however, much of this information supply is effectively noise rather than signal. The very general question that a significant portion of the economy is designed to address, then, is: “how can communications modes be created, that are better at delivering signal rather than noise?”

According to some embodiments, consumers of information or knowledge desire two fundamental qualities: 1) an increasingly large amount of information should be available to them, and 2) they want to be increasingly selective in their consumption of the information. Unfortunately, these two desires generally compete—in other words, there is a trade-off. This simply follows from the fact that, although information is highly valuable, the time of information consumers have is also highly valuable.

The following describes the basic elements of information quantity and selectivity according to some embodiments. First, from an information quantity standpoint, information consumers desire two concurrent qualities: 1) they want breadth of information, and 2) they want depth of information. By breadth, it is meant a boundarylessness of information across categories or domains. By depth, it is meant the ability to get more and more details of information within a category or domain. The key point of both of these information volumetric dimensions is that the fewer boundaries there are, the better—because boundaries are costly for information consumers. When there are boundaries, either information cannot be found at all, or time is wasted in having to jump the boundary to seek related information. Taken together, we can refer to the breadth and depth as the comprehensiveness of a set of information.

According to some embodiments, from the standpoint of information selectivity, information consumers also want two qualities: 1) they want the highest possible quality of information, and 2) they want information that is most relevant to their particular requirements. By quality of information, it is meant that which is the most recent, most authoritative on the subject, and most free of extraneous information. By relevant, it is meant information that is most focused on the consumers' particular requirements—customized for information consumers' particular situation, preferences or interests. Taken together, the combination of quality and relevance can be referred to as the signal-to-noise ratio, echoing communications theory.

Information consumers desire both comprehensiveness and high signal-to-noise rations; however, for any given transmission and/or delivery mode, there is a trade-off between these communications attributes. Given a transmission mode, or more broadly, a communications, knowledge, or content management infrastructure, a choice can be made regarding the best trade-off between comprehensiveness and signal-to-noise. It is only possible to make dual improvements in the attributes by applying more advanced technologies or infrastructures. The fields of publishing, broadcasting, telecommunications and computing are all examples of elements of our communications infrastructure in its broadest sense.

### Knowledge and Content Lifecycle Strategy

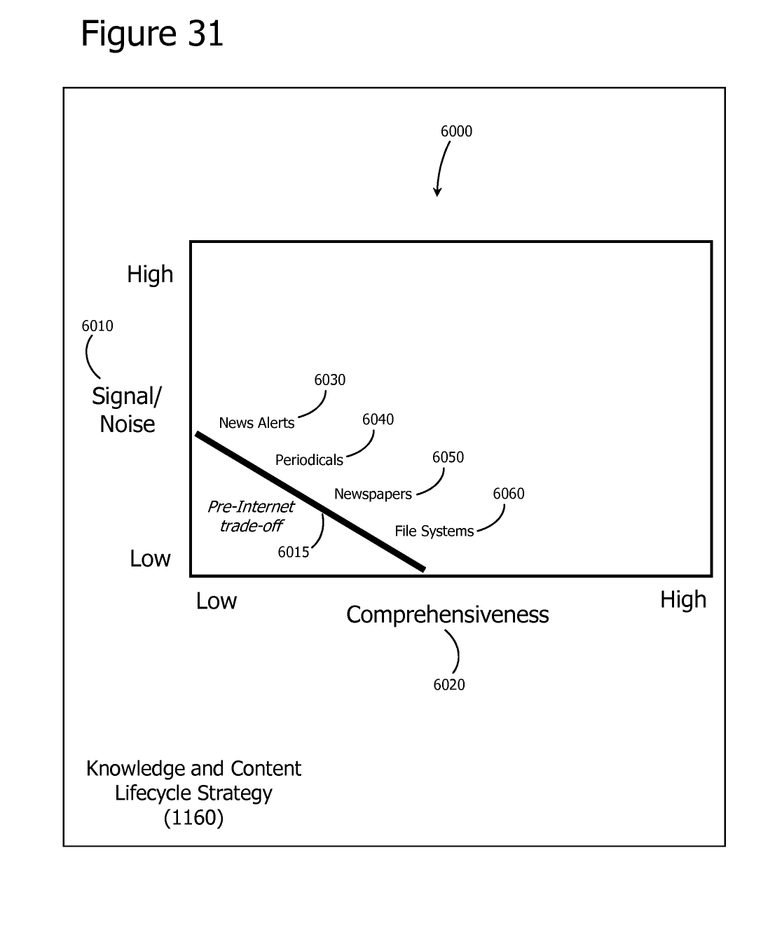

According to some embodiments, FIG. 31 depicts a knowledge and content lifecycle model 6000 within knowledge and content lifecycle strategy 1160 that applies the dimensions of signal/noise 6010 and comprehensiveness of information 6020. There have always been trade-offs between comprehensiveness and signal-to-noise ratios, with different information delivery modes optimized for a particular trade-off choice. For example, in publishing, periodicals 6040 are often focused on a particular domain for a particular customer segment, so that the signal-to-noise ratio is high. On the other hand, the comprehensiveness is relatively low due to a periodical's focus and non-continuous format. Newspapers 6050, alternatively, typically optimize more for comprehensiveness as they are less focused with regard to both content and customer segment, and they are delivered more frequently than periodicals. For on-line infrastructure, domain-specific news alerts (perhaps delivered by e-mail) 6030 represent a high signal/noise ration, but low comprehensiveness. On the other hand, general computer-based flat file systems 6060 exhibit potentially very high comprehensiveness, but the signal/noise ration is likely to be low. A trade-off frontier 6015 is collectively determined by the available publishing, broadcasting, telecommunications, and computer infrastructure available at a given time to a given organization or application.

Changes in infrastructure may enable the trade-off frontier 6015 to beneficially shift outward in model 6000—improving to some degree in both directions. The Web-based Internet represents such a break-through in shifting the trade-off curve between comprehensiveness and signal-to-noise.

It is true that prior to the Internet, computer-based applications certainly played an important role in the communications infrastructure. E-mail was certainly one obvious example. However, the Internet Protocol (IP) was a significant advance in that it enabled virtually universal connectivity. And the advent of the web browser enabled nearly universal publishing of information or knowledge.

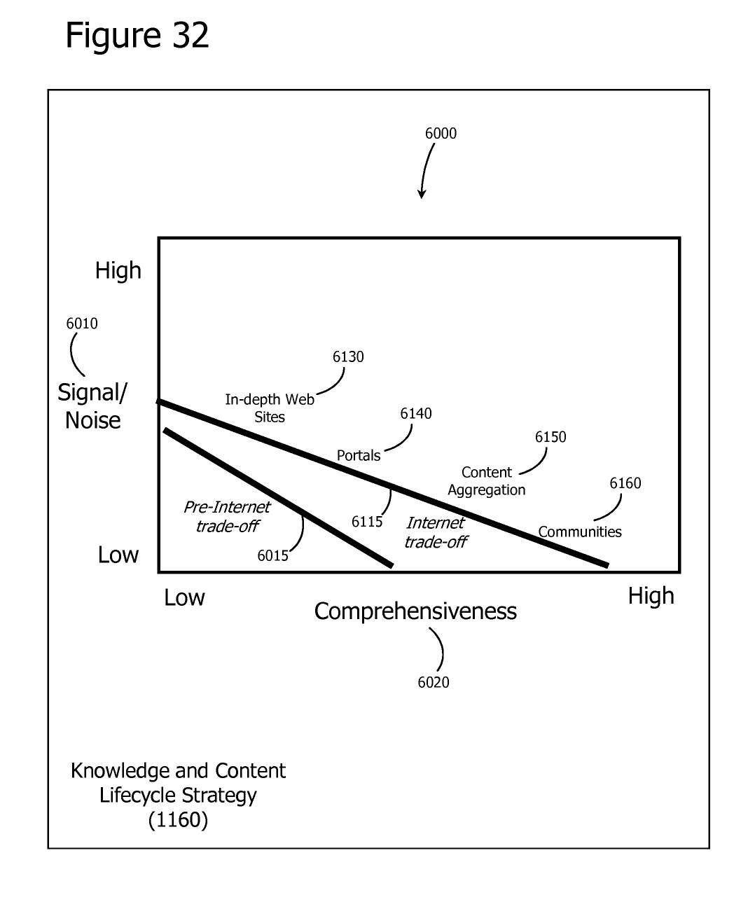

Nevertheless, even with the application of Internet-based infrastructure, as shown in FIG. 32, there is still a trade-off 6115 between comprehensiveness and signal-to-noise ratio dimensions, although a more favorable trade-off than with previous communications infrastructures.

For example, highly focused, in-depth and/or exclusive web sites 6130 can deliver high signal-to-noise, but are relatively low in comprehensiveness. At the other end of the spectrum, on-line communities 6160 are typically very comprehensive, but the signal-to-noise ratio is generally quite low, due to most “content” being generated by those with a relatively low cost of time—which indirectly implies limited general demand for their information. In between these extremes are, for example, general web portals 6140, and generalized content aggregation services 6150.

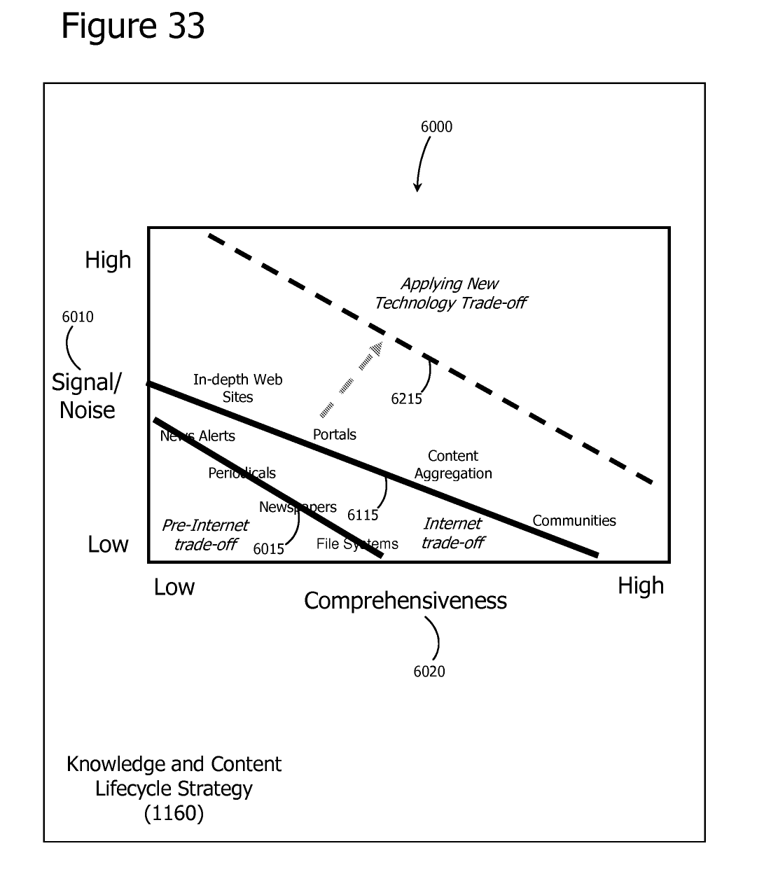

According to some embodiments, as shown in FIG. 33, applying new technical infrastructures or knowledge management approaches may enable a beneficial shifting of the trade-off frontier 6215.

According to some embodiments, the knowledge and content lifecycle model 6000 implies that it is important to segment communications and knowledge management approaches according to how various information consumers at specific times or within specific contexts prefer to be positioned on the trade-off curve 6215. For example, for business executives, who have the highest cost of time, a customized structure that maximizes signal-to-noise at the expense of some comprehensiveness is critical, while for knowledge worker communities, optimizing for comprehensiveness is generally more appropriate. A portfolio of communications approaches and media may managed according to information consumer segments.

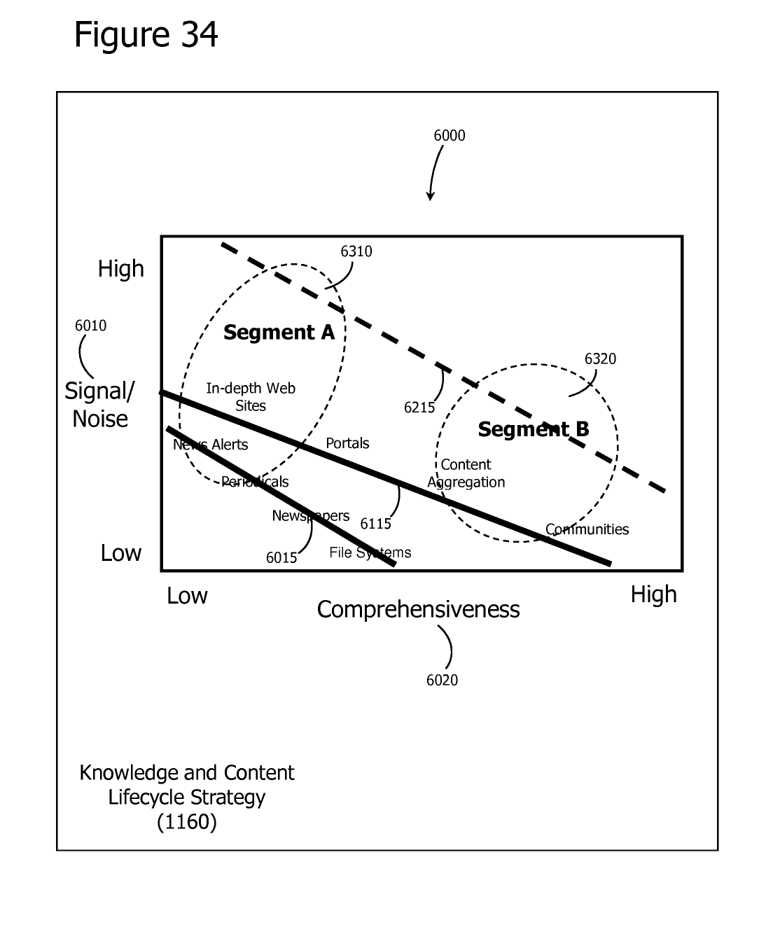

As an example, FIG. 34 depicts two consumer segments mapped to the knowledge and content lifecycle model 6000. The first segment, segment A 6310, is consistent with a set of consumers of information whose opportunity cost of time is high. Therefore the portfolio of knowledge management and content delivery approaches is oriented with high signal/noise ratios at the expense of comprehensiveness. The knowledge management and content delivery approaches may span multiple infrastructure types, e.g., publishing and on-line approaches. Segment B 6320 is consistent with an information consumer segment that values comprehensiveness relatively more than high signal/noise rations, presumably due to a relative low opportunity cost of time.

### Computer-Based Implementations of Business Lifecycle Management

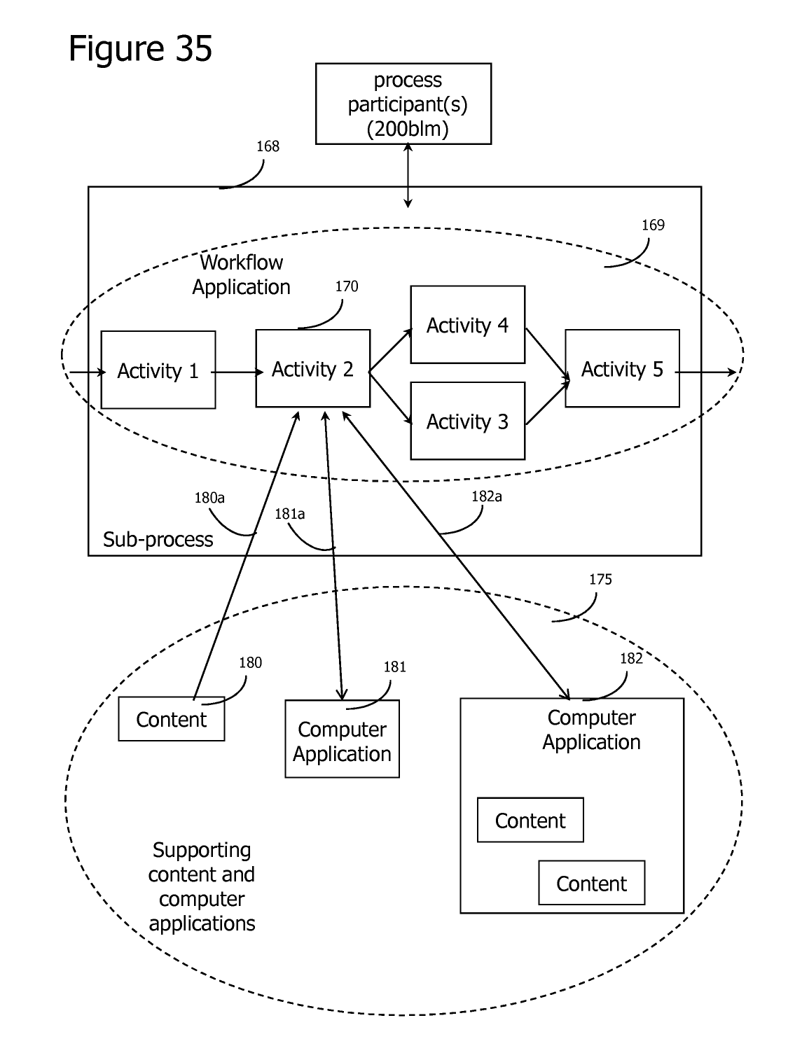

FIG. 35 illustrates a general approach to information and computing infrastructure support for implementation of business lifecycle management within a computer application-supported process. Some or all of the elements of the integrated business lifecycle management model 1000 may be implemented as a business process. The elements of the integrated business lifecycle management model 1000 may include activities, procedures, frameworks, models, algorithms, and sub-processes, and may map to process activities, sub-processes, processes, and/or workflow. It should be understood that FIG. 35 represents an exemplary process instantiation of the integrated business lifecycle management model 1000.

In FIG. 35, the workflow of activities within a business lifecycle management process or sub-process 168 may be managed by a computer-based workflow application 169 that enables the appropriate sequencing of workflow. Each activity, as for example “Activity 2” 170, may be supported by on-line content or computer applications 175. On-line content or computer applications 175 include pure content 180, a computer application 181, and a computer application that includes content 182. Information or content may be accessed by the sub-process 168 from each of these sources, shown as content access 180a, information access 181a, and information access 182a.

For example, content 180 may be accessed 180a (a content access 180a) as an activity 170 is executed. Although multiple activities are depicted in FIG. 3, a process or sub-process may include only one activity. The term “content” is defined broadly herein, to include text, graphics, video, audio, multi-media, computer programs or any other means of conveying relevant information. During execution of the activity 170, an interactive computer application 181 may be accessed. During execution of the activity 170, information 181a may be delivered to, as well as received from the computer application 181. A computer application 182, accessible by participants 200blm in the business lifecycle management process during execution of the activity 170, and providing and receiving information 182a during execution of the activity 170, may also contain and manage content such that content and computer applications and functions that support an activity 170 may be combined within a computer application 182. An unlimited number of content and computer applications may support a given activity, sub-process or process. A computer application 182 may directly contain the functionality to manage workflow 169 for the sub-process 168, or the workflow functionality may be provided by a separate computer-based application.

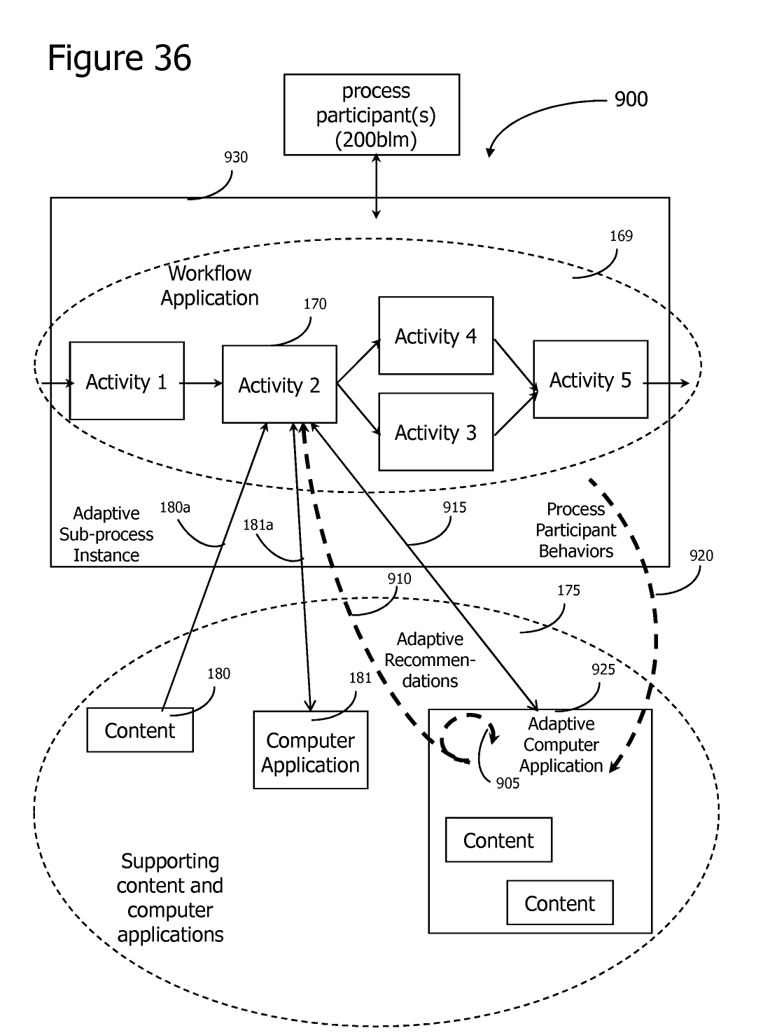

FIG. 36 depicts the application of adaptive recommendations to support an adaptive business lifecycle management process or sub-process, according to some embodiments. According to some embodiments, business lifecycle management may further be implemented as an adaptive process or sub-process. Business lifecycle management may apply the methods and systems disclosed in PCT Patent Application No. PCT/US2005/011951, entitled “Adaptive Recombinant Processes,” filed on Apr. 8, 2005, which is hereby incorporated by reference as if set forth in its entirety.

In FIG. 36, the adaptive business lifecycle management process 900 may include many of the features of the business lifecycle management process in FIG. 35. Thus, the adaptive process instance 930 features the workflow application 169, if applicable, with multiple activities 170, one or more of which may be linked. Further, the adaptive computer-based application 925 is depicted as part of supporting content and computer applications 175.

One or more participants 200blm in the adaptive process instance 930 generate behaviors associated with their participation in the process instance 930. The participation in the process instance 930 may include interactions with computer-based systems 181 and content 180, such as content access 180a and information access 181a, but may also include behaviors not directly associated with interactions with computer-based systems or content.

Process participants 200blm may be identified by the adaptive computer-based application 925 through any means of computer-based identification, including, but not limited to, sign-in protocols or bio-metric-based means of identification; or through indirect means based on identification inferences derived from selective process usage behaviors 920.

The adaptive business lifecycle management process 900 includes an adaptive computer-based application 925, which includes one or more system elements or objects, each element or object being executable software and/or content that is meant for direct human access. The adaptive computer-based application 925 tracks and stores selective process participant behaviors 920 associated with a process instance 930. It should be understood that the tracking and storing of selective behaviors by the adaptive computer-based application 925 may also be associated with one or more other processes, sub-processes, and activities other than the process instance 930. In addition to the direct tracking and storing of selective process usage behaviors, the adaptive computer-based application 925 may also indirectly acquire selective behaviors associated with process usage through one or more other computer-based applications that track and store selective process participant behaviors.

FIG. 36 also depicts adaptive recommendations 910 being generated and delivered by the adaptive computer-based application 925 to process participants 200blm. The adaptive recommendations 910 are shown being delivered to one or more process participants 200blm engaged in “Activity 2” 170 of the adaptive process instance 930 in FIG. 4B. It should be understood that the adaptive recommendations 910 may be delivered to process participants 200blm during any activity or any other point during participation in a process or sub-process.

The adaptive recommendations 910 delivered by the adaptive computer-based application 925 are informational or computing elements or subsets of the adaptive computer-based application 925, and may take the form of text, graphics, Web sites, audio, video, interactive content, other computer applications, or embody any other type or item of information. These recommendations are generated to facilitate participation in, or use of, an associated process, sub-process, or activity. The recommendations are derived by combining the context of what the process participant is currently doing and the inferred preferences or interests of the process participant based, at least in part, on the behaviors of one or more process participants, to generate recommendations. As the process, sub-process or activity is executed more often by the one or more process participants, the recommendations adapt to become increasingly effective. Hence, the adaptive business lifecycle management process 900 can adapt over time to become increasingly effective.

Furthermore, the adaptive recommendations 910 may be applied to automatically or semi-automatically self-modify 905 the structure, elements, objects, content, information, or software of a subset 1632 of the adaptive computer-based application 925, including representations of process workflow. (The terms “semi-automatic” or “semi-automatically,” as used herein, are defined to mean that the described activity is conducted through a combination of one or more automatic computer-based operations and one or more direct human interventions.) For example, the elements, objects, or items of content of the adaptive computer-based application 925, or the relationships among elements, objects, or items of content associated with the adaptive computer-based application 925 may be modified 905 based on inferred preferences or interests of one or more process participants. These modifications may be based solely on inferred preferences or interests of the one or more process participants 200blm derived from process usage behaviors, or the modifications may be based on inferences of preferences or interests of process participants 200blm from process usage behaviors integrated with inferences based on the intrinsic characteristics of elements, objects or items of content of the adaptive computer-based application 925. These intrinsic characteristics may include patterns of text, images, audio, or any other information-based patterns.

For example, inferences of subject matter based on the statistical patterns of words or phrases in a text-based item of content associated with the adaptive computer-based application 925 may be integrated with inferences derived from the process usage behaviors of one or more process participants to generate adaptive recommendations 910 that may be applied to deliver to participants in the process, or may be applied to modify 905 the structure of the adaptive computer-based application 925, including the elements, objects, or items of content of the adaptive computer-based application 925, or the relationships among elements, objects, or items of content associated with the adaptive computer-based application 925.

Structural modifications 905 applied to the adaptive computer-based application 925 enables the structure to adapt to process participant preferences, interests, or requirements over time by embedding inferences on these preferences, interests or requirements directly within the structure of the adaptive computer-based application 925 on a persistent basis.

Adaptive recommendations generated by the adaptive computer-based application 925 may be applied to modify the structure, including objects and items of content, of other computer-based systems 175, including the computer-based workflow application 169, supporting, or accessible by, participants in the process instance 930. For example, a system that manages workflow 169 may be modified through application of adaptive recommendations generated by the adaptive computer-based application 925, potentially altering activity sequencing or other workflow aspects for one or more process participants associated with the adaptive process instance 930.

In addition to adaptive recommendations 910 being delivered to process participants 200blm, process participants 200blm may also access or interact 915 with adaptive computer-based application 925 in other ways. The access of, or interaction with, 915 the adaptive computer-based application 925 by process participants 200blm is analogous to the interactions 182a with computer application 182 of FIG. 35. However, a distinguishing feature of adaptive process 900 is that the access or interaction 915 of the adaptive computer-based application 925 by process participants 200blm may include elements 1632 of the adaptive computer-based application 925 that have been adaptively self-modified 905 by the adaptive computer-based application 925.

### Computing Infrastructure

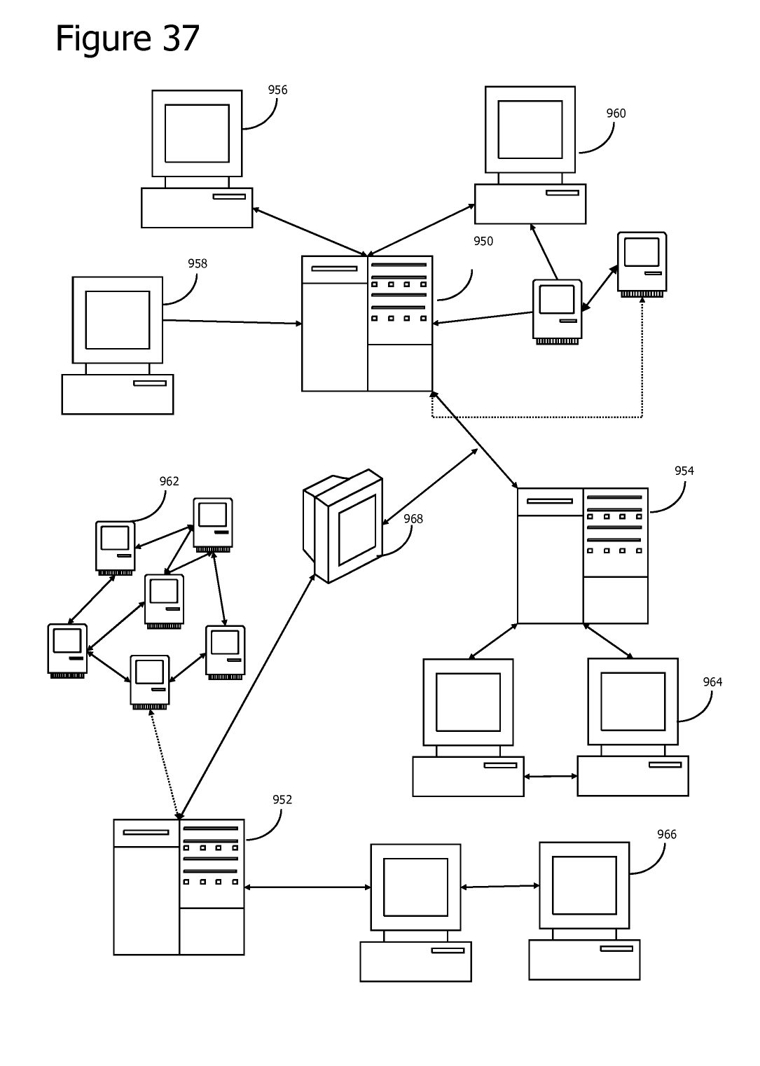

FIG. 37 depicts various hardware topologies that the integrated business lifecycle management model 1000 may embody. Servers 950, 952, and 954 are shown, perhaps residing at different physical locations, and potentially belonging to different organizations or individuals. A standard PC workstation 956 is connected to the server in a contemporary fashion. In this instance, the business lifecycle management, in part or as a whole, may reside on the server 950, but may be accessed by the workstation 956. A terminal or display-only device 958 and a workstation setup 960 are also shown. The PC workstation 956 may be connected to a portable processing device (not shown), such as a mobile telephony device, which may be a mobile phone or a personal digital assistant (PDA). The mobile telephony device or PDA may, in turn, be connected to another wireless device such as a telephone or a GPS receiver.

FIG. 37 also features a network of wireless or other portable devices 962. The relevant systems may reside, in part or as a whole, on all of the devices 962, periodically or continuously communicating with the central server 952, as required. A workstation 964 connected in a peer-to-peer fashion with a plurality of other computers is also shown. In this computing topology, the relevant systems, as a whole or in part, may reside on each of the peer computers 964.

Computing system 966 represents a PC or other computing system, which connects through a gateway or other host in order to access the server 952 on which the relevant systems, in part or as a whole, reside. An appliance 968, includes software “hardwired” into a physical device, or may utilize software running on another system that does not itself host the relevant systems. The appliance 968 is able to access a computing system that hosts an instance of one of the relevant systems, such as the server 952, and is able to interact with the instance of the system.

The integrated business lifecycle management model 1000 may utilize database management systems, including relational database management systems, to manage to manage associated data and information, including objects and/or relationships among objects.

While the present invention has been described with respect to a limited number of embodiments, those skilled in the art will appreciate numerous modifications and variations therefrom. For instance, it may be appreciated that business lifecycle management of the present invention may furthermore integrate with the ManyWorlds Generative Investment™, Adaptive Decision Processes and Adaptive Recombinant Processes methodologies. As another for instance, it may be appreciated that metrics may be defined with respect to non-financial indicia such as volume, supply, demand, system throughput, or other performance or efficiency or resource management indicia. It may further be appreciated that metrics, data, and/or representations of activities associated with business or process strategies may be implemented as an algorithm within a processor, such as a digital signal processor or computer or other data processing device or system or a network thereof. It is intended that the appended claims cover all such modifications and variations as fall within the true spirit and scope of this present invention.

What is claimed is:

1. A process lifecycle management method comprising:
interacting with a computer-implemented workflow system wherein the workflow system comprises representations of a plurality of business lifecycle management steps;
performing a business lifecycle management process step of establishing a business process lifecycle strategy in accordance with a business strategy; and
determining business process migrations in the context of a process lifecycle management framework.

2. The method of claim 1, further comprising:
establishing the current position of a process on the process lifecycle framework;
establishing a desired future position of the process on the process lifecycle framework; and
generating a strategy for the process based on, at least in part, the path between the current position and the desired future position of the process.

3. The method of claim 1, further comprising:
establishing a framework for categorizing a process, the framework comprising:
a first quadrant, wherein first quadrant processes are decentralized and standardized;
a second quadrant, wherein second quadrant processes are decentralized and customized;
a third quadrant, wherein third quadrant processes are centralized and standardized;
a fourth quadrant, wherein fourth quadrant processes are centralized and customized.

4. The method of claim 1, further comprising:
establishing a plurality of competitive dimensions;
applying the plurality of competitive dimensions to establish a strategic positioning framework; and
generating a strategic position for the business on the strategic positioning framework.

5. The method of claim 1, further comprising:
interacting with a graphical strategic positioning framework.

6. The method of claim 1, further comprising:
applying a decision model.

7. The method of claim 1, further comprising:
applying an industry lifecycle model.

8. The method of claim 1, further comprising:
establishing value drivers.

9. The method of claim 1, further comprising:
applying a solution lifecycle framework.

10. The method of claim 1, further comprising:
applying a product lifecycle framework.

11. The method of claim 1, further comprising:
applying a customer lifecycle framework.

12. The method of claim 1, further comprising:
applying a knowledge lifecycle framework.

13. The method of claim 1, further comprising:
determining a strategy for a process functionality layer.

14. The method of claim 1, further comprising:
receiving a computer-generated process step recommendation.

15. A solution lifecycle management method comprising:
interacting with a computer-implemented workflow system wherein the workflow system comprises representations of a plurality of solution lifecycle process steps;
performing a solution lifecycle process step of establishing customer value drivers;
performing a solution lifecycle process step of managing a capability network; and
assembling a plurality of capabilities of the capability network into a solution in accordance with the customer value drivers.

16. The method of claim 15, further comprising:
applying a product lifecycle framework.

17. The method of claim 15, further comprising:
applying a customer lifecycle framework.

18. The method of claim 15, further comprising:
assessing solution performance.

19. The method of claim 15, further comprising:
applying a knowledge lifecycle framework.

20. The method of claim 15, further comprising:
receiving a computer-generated process step recommendation.
